(19) United States
(12) Patent Application Publication
(10) Pub. No.: US 2026/0119846 A1
(43) Pub. Date: Apr. 30, 2026

(54) HYPERNETWORK FOR GENERATIVE MODEL

(71) Applicant: QUALCOMM Incorporated, San Diego, CA (US)

(72) Inventors: Eric HEDLIN, San Diego, CA (US); Shweta MAHAJAN, San Diego, CA (US); Munawar HAYAT, San Diego, CA (US); Fatih Murat PORIKLI, San Diego, CA (US)

(21) Appl. No.: 18/933,378

(22) Filed: Oct. 31, 2024

(51) Int. Cl. G06N 3/0475; G06N 3/08

(52) U.S. Cl. CPC G06N 3/0475; G06N 3/08

(57) ABSTRACT

A device includes a memory configured to store a hypernetwork and a generative model. The device also includes one or more processors, coupled to the memory. The one or more processors are configured to obtain a media input, and generate an encoded latent input based on the media input. The one or more processors are also configured to query, based on the encoded latent input, the hypernetwork to generate weights. The one or more processors are configured to generate, via the generative model initialized based on the generated weights, a media output based on the media input.

### I. FIELD

The present disclosure is generally related to a hypernetwork for a generative model, and more particularly to techniques associated with customization or personalization of a generative model.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Advances in generative models have enabled users to personalize such models through use of a set of examples provided by the user. For example, for an image generative model, the user provides a set of examples that includes multiple images, such as multiple images of a dog. To personalize a generative model for the set of examples, the generative model is typically retrained on the set of examples, which can be computationally expensive and be time consuming. For example, each time a new set of examples is provided, the generative model is retrained to generate a trained generative model and the retrained generative model (i.e., a personalized generative model) is stored for use. To reduce the compute expense and the time for retraining the generative model, some personalization techniques for generative models utilize hypernetworks. The hypernetworks can be trained on the set of examples to predict weights to be used for the generative model. Current hypernetworks generate training data by requiring task-specific networks to converge for each data sample, a process that is highly time-consuming due to the need for input and corresponding ground truth network weights. Additionally, while hypernetworks are generally more lightweight (e.g., have a smaller storage size) than the generative model and can be less computationally expensive and time consuming to train, a hypernetwork typically overfits a single training example. Accordingly, to personalize a generative model for set of examples that includes five examples, five hypernetworks would be generated—i.e., one hypernetwork for each example. Thus, the number of hypernetworks grows linearly with the number of samples to be used to personalize the generative model. The linear growth of the number of hypernetworks (based on the number of samples) makes personalizing a generative model based on a large number of samples impractical.

### III. SUMMARY

According to one implementation of the present disclosure, a device includes a memory configured to store a hypernetwork and a generative model. The device also includes one or more processors, coupled to the memory. The one or more processors are configured to obtain a media input, and generate an encoded latent input based on the media input. The one or more processors are also configured to query, based on the encoded latent input, the hypernetwork to generate weights. The one or more processors are configured to generate, via the generative model initialized based on the generated weights, a media output based on the media input.

According to another implementation of the present disclosure, a method includes obtaining a media input, and generating an encoded latent input based on the media input. The method also includes querying, based on the encoded latent input, a hypernetwork model to generate weights. The method includes generating, via a generative model initialized based on the generated weights, a media output based on the media input.

According to another implementation of the present disclosure, a non-transitory computer-readable medium stores instructions that are executable by one or more processors to cause the one or more processors to obtain a media input, and generate an encoded latent input based on the media input. The instructions also cause the one or more processors to query, based on the encoded latent input, a hypernetwork model to generate weights. The instructions further cause the one or more processors to generate, via a generative model initialized based on the generated weights, a media output based on the media input.

According to another implementation of the present disclosure, an apparatus includes means for obtaining a media input, and means for generating an encoded latent input based on the media input. The apparatus also includes means for querying, based on the encoded latent input, a hypernetwork model to generate weights. The apparatus includes means for generating, via a generative model initialized based on the generated weights, a media output based on the media input.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system including a hypernetwork for a generative model, in accordance with one or more aspects of the present disclosure.

FIG. 2 is a block diagram of an example of a system to train a hypernetwork for a generative model, in accordance with one or more aspects of the present disclosure.

FIG. 3 is a diagram of an example of operations associated with the system of FIG. 2, in accordance with one or more aspects of the present disclosure.

FIG. 4 depicts graphs to illustrate an example of a training technique for a hypernetwork, in accordance with one or more aspects of the present disclosure.

FIG. 5 is a diagram of an example of an integrated circuit operable to generate media data based on a hypernetwork and a generative model, in accordance with some examples of the present disclosure.

FIG. 6 is a diagram of a mobile device operable to generate media data based on a hypernetwork and a generative model, in accordance with some examples of the present disclosure.

FIG. 7 is a diagram of a wearable electronic device operable to generate media data based on a hypernetwork and a generative model, in accordance with some examples of the present disclosure.

FIG. 8 is a diagram of a voice-controlled speaker system operable to generate media data based on a hypernetwork and a generative model, in accordance with some examples of the present disclosure.

FIG. 9 is a diagram of a camera operable to generate media data based on a hypernetwork and a generative model, in accordance with some examples of the present disclosure.

FIG. 10 is a diagram of a headset, such as a virtual reality, mixed reality, or augmented reality headset, operable to generate media data based on a hypernetwork and a generative model, in accordance with some examples of the present disclosure.

FIG. 11 is a diagram of a mixed reality or augmented reality glasses device operable to generate media data based on a hypernetwork and a generative model, in accordance with some examples of the present disclosure.

FIG. 12 is a diagram of an example of a vehicle operable to generate media data based on a hypernetwork and a generative model, in accordance with some examples of the present disclosure.

FIG. 13 is a diagram of an example of a method of generating media data based on a hypernetwork and a media generation model, in accordance with some aspects of the present disclosure.

FIG. 14 is a block diagram of an illustrative example of a device that is operable to generate media data based on a hypernetwork and a generative model, in accordance with one or more aspects of the present disclosure.

### V. DETAILED DESCRIPTION

The above-described problems associated with personalization of generative models are solved using a hypernetwork for a generative model, where the hypernetwork has been trained on a set of examples as described herein. The present disclosure provides systems, devices, apparatus, methods, and computer-readable media for a hypernetwork (also referred to herein as a “hypernet”) trained to generate weights for a generative model to generate personalized media content. Some aspects more specifically relate to a device that includes an encoder to generate a latent representation of a media input, such as an image frame, video content, or audio content. The latent representation is provided to a hypernetwork trained to generate weights for initialization of a generative model. The weights (for the generative model) generated by the hypernetwork based on the latent representation may be used to initialize the generative model and the initialized generative model can generate a personalized media output. One technical advantage of implementing the hypernetwork as described above is that the hypernetwork enables a greater level of personalization of a generative model as compared to conventional personalization techniques because the hypernetwork can be efficiently trained on a large data set and in a shorter amount of time as compared to conventional training approaches for personalization of a generative model.

In some embodiments, the hypernetwork includes hypernetwork weights trained based on a set of examples associated with personalization of the generative model. To illustrate, the hypernetwork may include a single hypernetwork model having a set of hypernetwork weights trained according to an entirety of the set of examples (e.g., multiple training examples). For example, first hypernetwork weights of the hypernetwork determined based on training the hypernetwork on a first example (of the set of examples) may be used to initialize the hypernetwork for training on a second example (of the set of examples). To train the hypernetwork, a training system can be configured to supervise training of the hypernetwork to match a ground truth optimized trajectory of a task model, such as an occupancy model or a diffusion model. For example, the training system may supervise the ground truth optimized trajectory in a direction of steepest gradient descent as opposed to conventional hypernetwork training techniques which diffuse randomly. In some implementations, the training system is configured to diffuse or denoise an example of the set of examples and train the hypernetwork based on the diffused or denoised example.

One technical advantage of implementing the training of the hypernetwork as described above is that the training is less computationally expensive and time consuming as compared to conventional training approaches for personalization of a generative model. Additionally, the training techniques described herein enable a hypernetwork for a generative model to be trained on a large data set and in a shorter amount of time as compared to conventional training approaches for personalization of a generative model, thereby enabling a greater level of personalization and training that is not limited or restricted based on precompute requirements. Additionally, the training techniques described herein can optimize all samples along with the hypernetwork itself, thereby ensuring compatibility across samples and eliminating large precompute costs. By supervising the hypernetwork to match the gradients of the optimization trajectory, the techniques described herein may estimate partially converged weights for all timesteps, which can significantly reduce compute requirements. Compared to conventional approaches, the techniques described herein may ensure smooth weight changes and efficient training, and demonstrates superior performance with a significantly larger training dataset, reduced training time, and fewer inference steps.

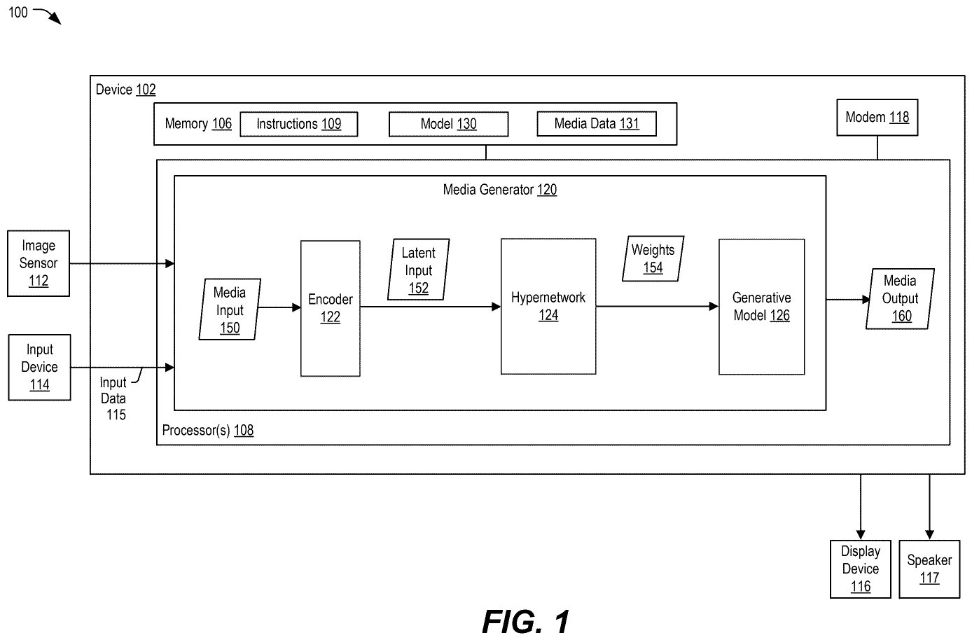

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

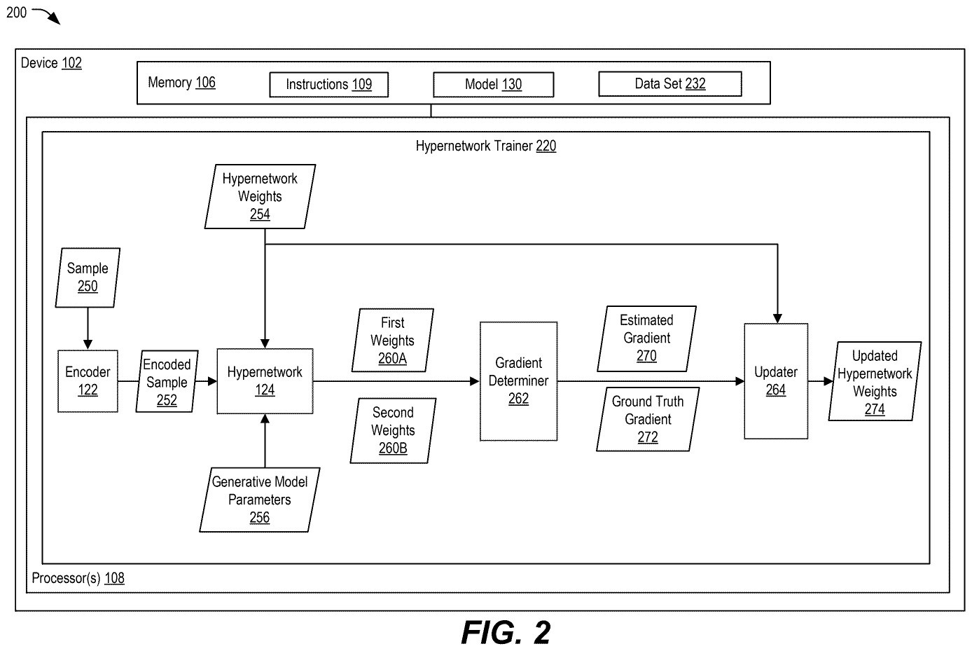

In some drawings, multiple instances of a particular type of feature are used. Although these features are physically and/or logically distinct, the same reference number is used for each, and the different instances are distinguished by addition of a letter to the reference number. When the features as a group or a type are referred to herein—e.g., when no particular one of the features is being referenced, the reference number is used without a distinguishing letter. However, when one particular feature of multiple features of the same type is referred to herein, the reference number is used with the distinguishing letter. For example, referring to FIG. 2, multiple sets of weights are illustrated and associated with reference numbers 260A and 260B. When referring to a particular one of these sets of weights, such as weights 260A, the distinguishing letter “A” is used. However, when referring to any arbitrary one of these sets of weights or to these sets of weights as a group, the reference number 260 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components. As used herein, “via” may include or indicate by, by way of, through use of, with, or using.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data,” The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

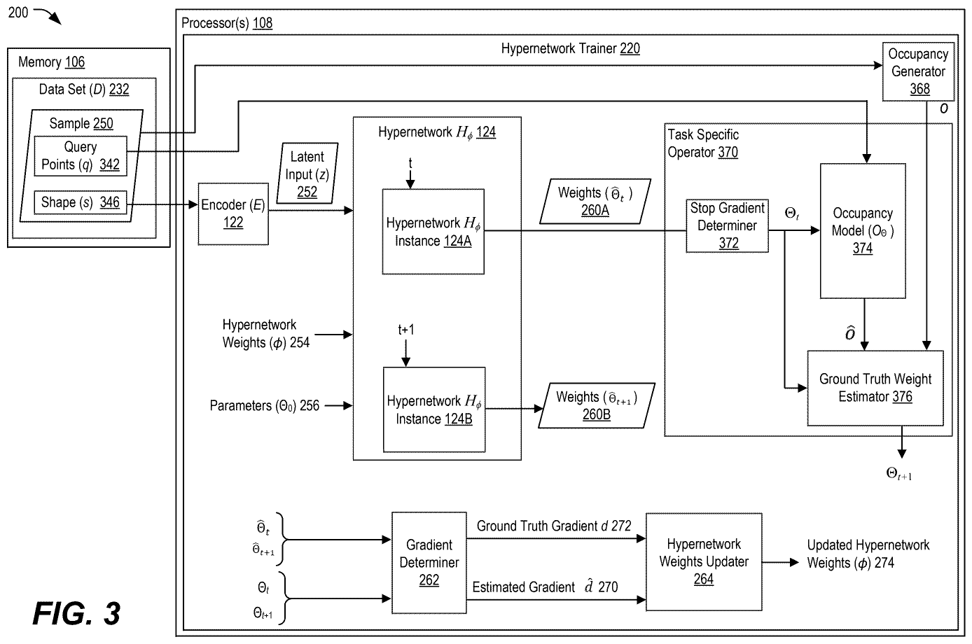

FIG. 1 is a block diagram of an example of a system 100 including a hypernetwork for a generative model, in accordance with one or more aspects of the present disclosure. The system 100 includes a device 102 that is operable to generate media data (e.g., a media output 160) based on a hypernetwork 124 and a generative model 126. Additionally, or alternatively, the device 102 can be configured to or operable to train one or more models, such as the hypernetwork 124, as described further herein at least with reference to FIGS. 2 and 3.

The device 102 includes a memory 106, one or more processors 108 (collectively referred to herein as the “processor 108”) coupled to the memory 106, and a modem 118. The memory 106 may include one or more memories, such as a single memory or multiple different memories (of the same type or of different types).

The memory 106 is configured to store instructions 109, one or more models 130 (collectively referred to herein as the “model 130”), and media data 131. In some examples, the memory 106 stores the instructions 109 that, when executed by the processor 108, cause the processor 108 to perform one or more operations as described herein.

The model 130 may include or be associated with an encoder 122, the hypernetwork 124, the generative model 126, another model, or a combination thereof. In some examples, the model 130 includes or indicates one or more parameters (e.g., one or more weights) for the model 130. The one or more parameters (e.g., the one or more weights) may be configured to be used to initialize the model 130. To illustrate, the one or more parameters (e.g., the one or more weights) may include trained hypernetwork weights that may be used to initialize the hypernetwork 124. The media data 131 may include or correspond to image data, audio data, video data, game data, graphics data, or a combination thereof, as illustrative, non-limiting examples. In some embodiments, the media data 131 includes media content that was used to train the model 130. As an illustrative, non-limiting example, the media data 131 may include image data that was used to determine the trained hypernetwork weights of the hypernetwork 124. In some embodiments, the memory 106 is configured to store additional data, such as media content, training data, or a combination thereof.

In the example illustrated in FIG. 1, the processor 108 includes a media generator 120. The media generator 120, or portions thereof, may be implemented by the processor 108 executing the instructions 109 (e.g., software), dedicated hardware (e.g., circuitry), a combination thereof. The media generator 120 is configured to perform one or more media generation operations associated with generation of media content. In some embodiments, to generate the media content, the media generator 120 includes and/or initializes the encoder 122, the hypernetwork 124, and the generative model 126.

The encoder 122 is configured to receive an input, such as a media input 150. The media input 150 may include image data, audio data, video data, game data, graphics data, random data (e.g., a random gaussian), or a combination thereof, as illustrative, non-limiting examples. In some embodiments, the media input 150 is obtained from the media data 131 or from another media source, such as an image sensor 112 (e.g., a camera). Additionally, or alternatively, the media input 150 may be provided or selected by a user of the device 102, or may be randomly selected from the media data 131 by the media generator 120.

The encoder 122 is configured to generate a latent input 152 based on the media input 150. For example, the encoder 122 may include a neural network configured to extract latents (e.g., low dimensional representations) associated with the media input 150. In some such examples, the encoder 122 performs one or more operations to compress the media input 150 into the latent space. To illustrate, the encoder 122 receives the media input 150 and performs the one or more operations to generate the latent input 152. In some examples, the encoder 122 is, includes, or is included in an autoencoder, such as a variational autoencoder (VAE). To illustrate, the autoencoder may generate the latent input 152 (e.g., the encoded latent input) based on the media input 150.

The hypernetwork 124 is configured to generate a set of weight values to be used to initialize the generative model 126. For example, the hypernetwork 124 may have been trained on a data set of multiple training examples, as described further herein at least with reference to FIG. 2. For example, hypernetwork weights used to initialize the hypernetwork 124 may have been trained on the data set of multiple training examples. In some embodiments, the multiple training examples of the data set used to train the hypernetwork 124 include multiple media inputs (e.g., multiple images) provided by a user to enable a customized or personalized implementation of the generative model 126. For example, the hypernetwork 124 may have been trained using the data set of the multiple training examples such that hypernet weights φ (for the hypernetwork 124) are learned during training to enable the hypernetwork 124 to produce (e.g., output) weights 154 for the generative model 126. In some aspects, the hypernetwork 124 may include a single set of hypernetwork weights that has been determined based on training using the multiple training examples of the data set.

The generative model 126 is a machine learning model that has been trained to generate output data, such as media output 160. The generative model 126 may be initialized based on the weights 154. In some embodiments, the generative model 126 includes a diffusion model or an occupancy model.

The modem 118 is coupled to the processor 108 and is configured to send data to another device. For example, the modem 118 can transmit media content (e.g., the media output 160 generated based on the media input 150) to a second device for output by the second device. Additionally, or alternatively, as another example, the modem 118 can transmit the model 130, the media data 131, or a combination thereof, to the second device. For example, the processor 108 may receive a request to personalize the generative model and, in response to the request, the processor 108 may cause the modem 118 to send the model 130, the media data 131, or a combination thereof to the second device to train hypernetwork weights to be used to initialize the hypernetwork 124. In some embodiments, the modem 118 may be configured to receive data from another device. For example, the data received by the modem 118 may include model data (e.g., the model 130), one or more parameters or weights for a model, the media data 131, the media input 150 (e.g., image data, video data, or audio data), or a combination thereof.

In the example illustrated in FIG. 1, the processor 108 is also optionally coupled to an image sensor 112, an input device 114 (e.g., a microphone, a keyboard, touch screen, etc.), a display device 116, a speaker 117, or a combination thereof. The image sensor 112 may include one or more cameras and may be configured to generate the media input 150. Media content, such as the media output 160, may be generated by the processor 108 at least partially based on the media input 150.

The input device 114 is configured to receive an input and provide the input to the processor 108 as input data 115. For example, the input device 114 may include a keyboard, a touch screen, or a microphone configured to receive the input and provide the input data 115 (e.g., an input) to the processor 108. In some embodiments, the input may be received based on or in association with a prompt. The input data 115 may include or indicate a request to generate media content (e.g., video content), such as a request to generate the media output 160 based on the model 130 (e.g., the generative model 126) and the media input 150. In some examples, the input data 115 (e.g., the input) may indicate a selection of the media input 150, a unique identifier that corresponds to or indicates the hypernetwork 124 and/or the trained hypernetwork weights of the hypernetwork 124, or a combination thereof. Additionally, or alternatively, the input data 115 includes a request to perform a text-based video generation, a text-based video content editing operation, a video enhancement operation, video compression, a data augmentation operation, or a combination thereof.

The display device 116 is coupled to the processor 108 and is configured to output the media output 160, such as the media output 160 generated based on the media input 150. In some examples, the display device 116 includes a display screen, a monitor or television, a projector, or a combination thereof. In some embodiments, the device 102 (e.g., the processor 108) is configured to output audio associated with the media output 160 (e.g., video content) generated based on the input media data. For example, the audio may be output via the speaker 117. Additionally, or alternatively, the media output 160 may include audio data generated based on the hypernetwork 124 and/or the generative model 126, and the generated audio data (e.g., the media output 160) may be output via the speaker 117.

The image sensor 112, the input device 114, the display device 116, the speaker 117, or a combination thereof, may be coupled to or integrated within the device 102. In some implementations, one or more of the image sensor 112, the input device 114, the display device 116, or the speaker 117 may be included in another device that is coupled (e.g., communicatively coupled) to the device 102. For example, the other device may include a mobile device (e.g., a smart phone) or a wearable device (e.g., a smartwatch or headset) that includes the image sensor 112, the input device 114, the speaker 117, or a combination thereof. Although the device 102 is described as being coupled to or including the image sensor 112, the input device 114, the display device 116, the speaker 117, and the modem 118, in other implementations the device 102 may not include or be coupled to the image sensor 112, the input device 114, the display device 116, the speaker 117, the modem 118, or a combination thereof.

During operation of the system 100, the processor 108 receives the input data 115 that includes or indicates a request to generate the media output 160. In some examples, the request includes a prompt, and the media output 160 is generated based on the prompt. To illustrate, the request may indicate to “Generate a video of a dog walking on a beach.” In some implementations, the processor 108 generates a text embedding based on at least a portion of the request and provides the text embedding as an input the generative model 126. Additionally, or alternatively, the request can be to perform a text-based media generation, a text-based media content editing operation, a media enhancement operation, or a combination thereof.

In response to the input data 115 (e.g., the request), the processor 108 obtains the model 130 from the memory 106. For example, in response to the input data 115, the processor 108 may obtain the encoder 122, the hypernetwork 124 (including the trained hypernetwork weights), the generative model 126, or a combination thereof. They hypernetwork 124 may be initialized based on the trained hypernetwork weights. In some embodiments, the processor 108 also may obtain the media input 150. For example, the input data 115 may include the media input 150 or the processor 108 may obtain, based on the input data 115, the media input 150 from the image sensor 112 or from the memory 106 (e.g., the media data 131).

The processor 108 provides the media input 150 to the encoder 122. The encoder 122 generates an encoded latent input (e.g., latent input 152) based on the media input 150. The processor 108 then provides the latent input 152 to the hypernetwork 124 to query the hypernetwork 124 based on the latent input 152. The hypernetwork 124 generates the weights 154 based on the latent input 152.

The processor 108 provides the weights 154 to the generative model 126 to initialize the generative model 126 based on the generated weights 154. After initialization of the generative model 126 based on the weights 154, the generative model 126 generates the media output 160. For example, the processor 108 may provide the media input 150, a text embedding of the input data 115, or a combination thereof, to the generative model 126 that has been initialized based on the weights 154, and the generative model 126 generates the media output 160 based on the media input 150, a text embedding of the input data 115, or a combination thereof.

In some embodiments, the processor 108 stores the media output 160 at the memory 106. Additionally, or alternatively, the processor 108 may send the media output 160 to the display device 116 and/or the speaker 117 for output (e.g., presentation) of the media output 160. The processor 108 may also send the media output to another device. For example, the processor 108 may cause the modem 118 to send the media output to the other device.

In some examples, the processor 108 may receive a request (e.g., the input data 115) to modify the media output 160. Based on the request to modify the media output 160, the processor 108 may modify at least one weight of the weights 154 initialized at the generative model 126. The processor 108 may then cause the generative model (having the modified at least one weight) to generate another media output based on the media input 150, the text embedding, or a combination thereof.

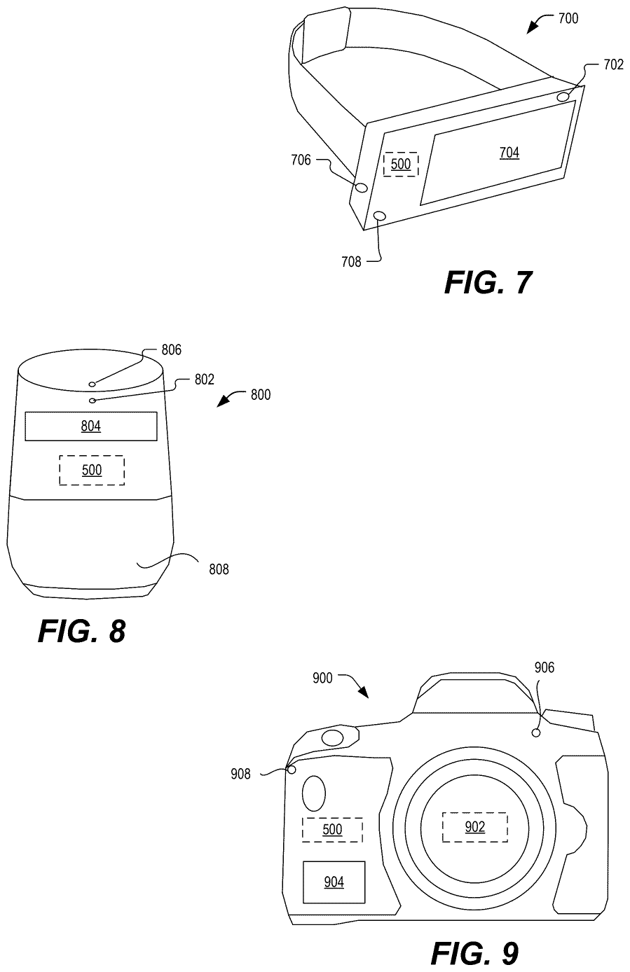

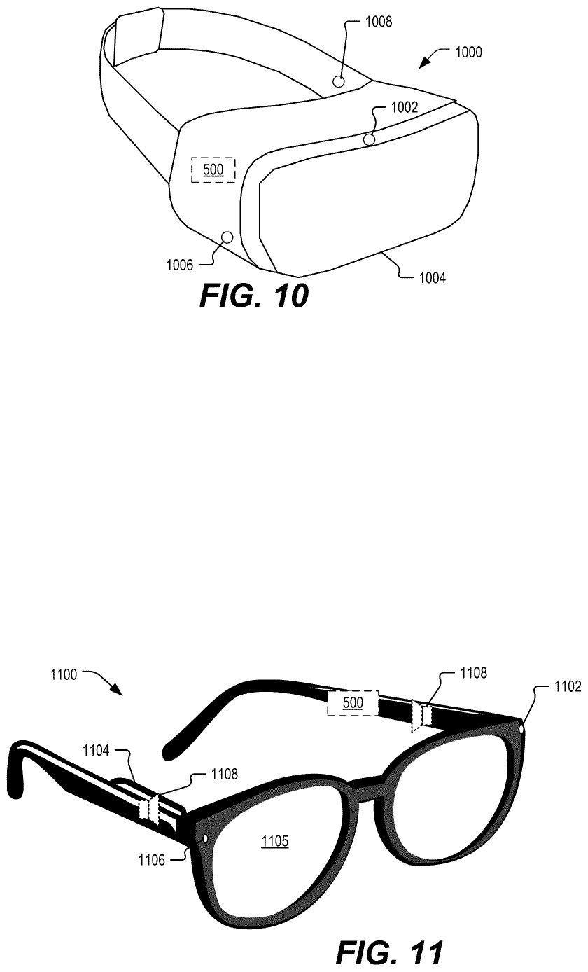

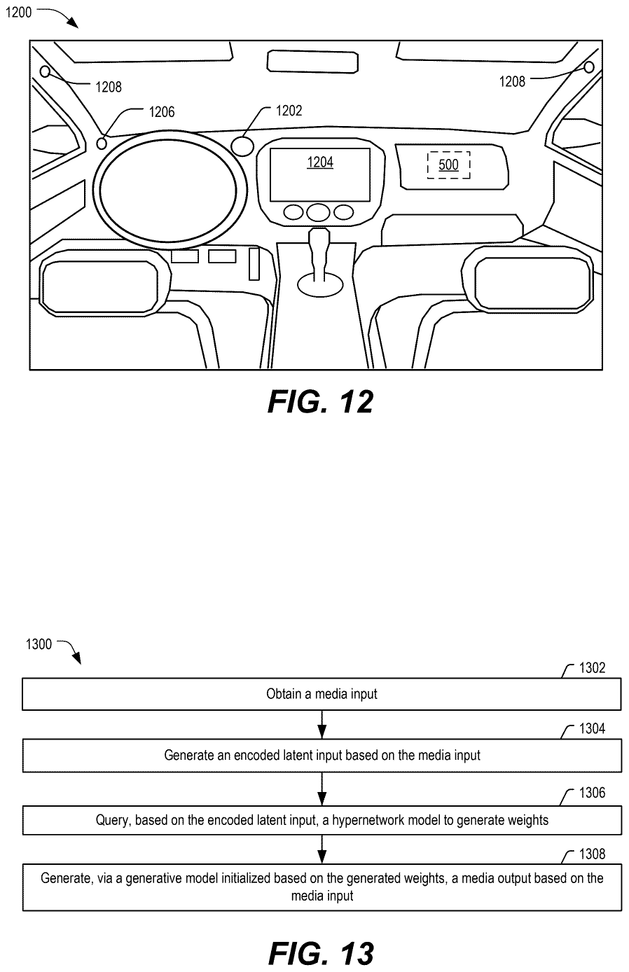

In some examples, the device 102 corresponds to or is included in one of various types of devices, such that the processor 108 can be integrated in multiple types of devices. In an illustrative example, the processor 108 is integrated in a wearable device, such as a wearable electronic device as depicted in FIG. 7, a virtual reality, mixed reality, or augmented reality headset as depicted in FIG. 10, a mixed reality or augmented reality glasses device as described with reference to FIG. 11, or another wearable device. In another illustrative example, the processor 108 is integrated in a mobile device (a mobile phone or a tablet) as depicted in FIG. 6, a voice-controlled speaker system as depicted in FIG. 8, a camera as depicted in FIG. 9, a vehicle as depicted in FIG. 12, a computer or a server, or another system or device.

One technical advantage of implementing the device 102 as described above is that the hypernetwork 124 includes or is associated with hypernetwork weights (e.g., trained hypernetwork weights) that have been trained according to a set of multiple training examples. For example, the hypernetwork 124 may be a single hypernetwork model having a single set of hypernetwork weights as compared to conventional approaches in which a different hypernetwork is trained for each example of the set of examples. Accordingly, the single hypernetwork may be stored using less storage space as compared to having to store one hypernetwork for each training example of multiple training examples. As another technical advantage, the device 102 may use the trained hypernetwork 124 (which is lightweight compared to the generative model 126) to personalize the generative model 126 rather than conventional approaches which retrain and store a trained generative model trained on the set of examples. Accordingly, the device 102 may store multiple trained hypernetworks as different personalizations of the same single generative model 126, which is more efficient than storing the same number of personalized (e.g., retrained) generative models. One technical advantage of implementing the hypernetwork 124 as described above is that the hypernetwork 124 enables a greater level of personalization of the generative model 126 when the hypernetwork 124 has been trained on a large data set that has not been limited or restricted based on precompute requirements.

FIG. 2 is a block diagram of an example of a system 200 to train the hypernetwork 124 for the generative model 126, in accordance with one or more aspects of the present disclosure. The system 200 includes the device 102 of FIG. 1. Although not expressly shown, the system 200 and/or the device 102 of FIG. 2 may include one or more components as described with reference to the system 100 and the device 102 of FIG. 1. For example, the system 200 may include the image sensor 112, the input device 114, the display device 116, the speaker 117, the modem 118, or a combination thereof. As another example, the device 102 of FIG. 2 may include the media generator 120.

The memory 106 is configured to store the instructions 109, the model 130, and a data set 232. The model 130 may include or be associated with the encoder 122, the hypernetwork 124, the generative model 126, a gradient determiner 262, an updater 264, or a combination thereof. The data set 232 includes multiple training examples, such a multiple training examples provided by a user that has requested personalization of the generative model 126 of FIG. 1. The multiple training examples may include or correspond to the media data 131. For example, the multiple training examples may include media data, such as image data, video data, audio data, or a combination thereof. In some embodiments, the multiple training examples of the data set 232 are provided by a user to enable a customized or personalized implementation of the generative model 126 of FIG. 1. In a particular embodiment, the multiple training examples of the data set 232 include the media input 150 of FIG. 1.

In the example illustrated in FIG. 2, the processor 108 includes a hypernetwork trainer 220. The hypernetwork trainer 220, or portions thereof, may be implemented by the processor 108 executing the instructions 109 (e.g., software), dedicated hardware (e.g., circuitry), a combination thereof. The hypernetwork trainer 220 is configured to perform one or more training operations associated with training hyperlink weights of the hypernetwork 124 for use with a generative model, such as the generative model 126.

The hypernetwork trainer 220 includes the encoder 122, the hypernetwork 124, a gradient determiner 262, and an updater 264. The encoder 122 is configured to receive the examples of the multiple training examples of the data set 232. To illustrate, the encoder 122 may receive a sample 250 that includes an example of the multiple training examples of the data set 232. In some embodiments, the hypernetwork trainer 220 may randomly select the example as the sample 250 from the multiple training examples of the data set 232. As an illustrative example, the sample 250 selected from the data set 232 may include the media input 150 of FIG. 1. The encoder 122 is configured to generate an encoded sample 252 based on the sample 250. The encoded sample 252 may include a representation of the sample 250. For example, the encoder 122 may include a neural network configured to extract latents (e.g., low dimensional representations) associated with the sample 250. In some such examples, the encoder 122 performs one or more operations to compress the sample 250 into the latent space.

The hypernetwork 124 is configured to generate multiple sets of estimated weights 260 (associated with the generative model 126 of FIG. 1), where each set of estimated weights is associated with a different timestep t. To illustrate, the hypernetwork 124 may be initialized with hypernetwork weights 254. The hypernetwork 124 may also receive and/or be initialized with generative model parameters 256, such as an occupancy model or a diffusion model, associated with the generative model 126 of FIG. 1. For each timestep t of multiple timesteps, the hypernetwork 124 may generate a set of weights 260 (e.g., a set of estimated weights), such as first weights 260A associated with a first timestep and second weights 260B associated with a second timestep, where the first timestep is prior to the second timestep.

The gradient determiner 262 is configured to determine multiple gradients, as described further herein at least with reference to FIG. 3. For example, the gradient determiner 262 may determine an estimated gradient 270 and a ground truth gradient 272. The estimated gradient 270 may be determined based on the first weights 260A and the second weights 260B. The ground truth gradient 272 may be determined based on the initial generative model parameters 256 and the first weights 260A.

The updater 264 is configured to generate updated hypernetwork weights 274 for the hypernetwork 124 based on the gradients (e.g., the estimated gradient 270 and the ground truth gradient 272) determined by the gradient determiner 262, as described further herein at least with reference to FIG. 3. The updated hypernetwork weights 274 may be provided to the hypernetwork 124 to initialize (e.g., re-initialize) the hypernetwork 124 for use with a next example, such as a next sample, from the data set 232. Alternatively, if all the examples of the multiple training examples of the data set 232 have been used (e.g., applied) by the hypernetwork trainer 220 to train the hypernetwork 124, the updated hypernetwork weights 274 may represent the trained hypernetwork weights of the hypernetwork 124 that has been trained on the data set 232.

During operation of the system 100, the processor 108 receives a request to train the hypernetwork 124 for use with the generative model 126 of FIG. 1. For example, the request may include or correspond to a request (e.g., the input data 115) to personalize the generative model 126 based on the data set 232 of multiple training examples. In some embodiments, the processor 108 may obtain the data set 232 of the multiple training examples as part of or based on the request. For example, the request may include or indicate the data set 232.

In response to the request, the processor 108 trains the hypernetwork 124 based on the data set 232 of the multiple training examples. For example, the processor 108 may train the hypernetwork 124 based on the multiple training examples to determine a set of trained hypernetwork parameters for the hypernetwork 124.

To train the hypernetwork 124, the processor 108 (e.g., the hypernetwork trainer 220) initializes the hypernetwork 124 based on the hypernetwork weights 254 and obtains the generative model parameters 256 (e.g., initial parameters of the generative model 126) that are provided to the hypernetwork 124 as an input to the hypernetwork 124. Additionally, the processor 108 selects the sample 250 from the data set 232 and provides the sample 250 to the encoder 122. In some embodiments, the sample 250 is a randomly selected sample that is selected by the processor 108 from the data set 232. The encoder 122 generates the encoded sample 252 that is provided to the hypernetwork 124.

Based on the random sample 250 (e.g., the encoded sample 252) the hypernetwork 124 determines the estimated weights 260 (associated with the generative model 126 of FIG. 1) for each of multiple timesteps. For example, the hypernetwork 124 generates the first weights 260A associated with a first timestep (e.g., t), and the second weights 260B associated with a second timestep (e.g., t+1) that is subsequent to the first timestep. The estimated weights 260 are provided to the gradient determiner 262.

The processor 108 (e.g., the gradient determiner 262) determines one or more gradients based on the first weights 260A, the second weights 260B, or a combination thereof. For example, the gradient determiner 262 can determine the estimated gradient 270 based on the first weights 260A and the second weights 260B. As another example, the gradient determiner 262 can determine the ground truth gradient 272 based on the generative model parameters 256 (e.g., the initial parameters of the generative model 126) and the first weights 260A. The processor 108 (e.g., the updater 264) may determine the updated hypernetwork weights 274 based on the estimated gradient 270 and the ground truth gradient 272.

In some embodiments, to train the hypernetwork 124 and determine a trained set of hypernetwork weights for use with the generative model 126, the processor 108 iteratively selects random samples from the data set 232 and, for each selected sample, determines updated hypernetwork weights that are used to initialize/update the hypernetwork 124 for a next selected random sample. When each of the examples (e.g., the multiple training examples) of the data set 232 have been selected, the final updated hypernetwork weights that are determined are designated as the trained hypernetwork weights for the hypernetwork 124.

Although the device 102 is described as including the hypernetwork trainer 220, in other embodiments, the hypernetwork trainer 220 may be included in a different device from the device 102. In some such embodiments, the device 102 of FIG. 1 may send a request for personalization to the other device which includes the hypernetwork trainer 220. Additionally, the device 102 of FIG. 1 may provide or identify the data set 232 to be used by the hypernetwork trainer 220 of the other device to train the hypernetwork 124 and determine the trained hypernetwork weights to be used to initialize the hypernetwork 124. The other device may send the trained hypernetwork weights to the device 102 of FIG. 1 for operation of the hypernetwork as described herein at least with reference to FIG. 1.

One technical advantage of implementing the training of the hypernetwork 124 as described above is that the training is less computationally expensive and time consuming as compared to conventional training approaches for personalization of a generative model based on the same number of multiple training examples. Additionally, the training techniques described herein enable the hypernetwork 124 for the generative model 126 to be trained on a large data set and in a shorter amount of time as compared to conventional training approaches for personalization of a generative model, thereby enabling a greater level of personalization and training that is not limited or restricted based on precompute requirements.

FIG. 3 is a diagram of an example of operations associated with the system 200 of FIG. 2, in accordance with one or more aspects of the present disclosure. As shown, the system 200 includes the memory 106 and the processor 108.

The memory 106 includes the data set (D) 232. The data set 232 includes the multiple training examples, such as the sample 250. The sample 250 may include or be associated with query points (q) 342 and a shape(s) 346. In some examples, the query points 342 include or correspond to locations (e.g., points) of the sample 250. Although the sample 250 is described as including the query points 342, in other embodiments, the query points 342 may be included in the data set 232 and may be common to each of the multiple training examples (e.g., multiple samples) included in the data set 232.

The processor 108 includes the hypernetwork trainer 220. The hypernetwork trainer 220 includes the encoder (E) 122, the hypernetwork H_{φ} 124, an occupancy generator 368, a task specific operator 370, the gradient determiner 262, and the hypernetwork weights updater 264.

The encoder (E) 122 may include a pretrained auto encoder, such as a VAE. The encoder 122, such as a shape encoder, is configured to receive the sample 250 (e.g., the shape 346) and generate a latent input (z) 252 of the sample 250.

The hypernetwork H_{φ} 324 is configured to generate estimated weights 260 for a timestep t, where t is included in [0, T], where 0 represents initialization and T is a total number of timesteps for full convergence. The hypernetwork H_{φ} 324 may be supervised by gradients of task-specific weights at each timestep, ∇_{Θ}_{ₜ}L (Θₜ, z), where ∇_{Θ}_{ₜ} is gradient associated with the parameters Θₜ, and L(Θ, z) is a loss function given an input z. As shown in FIG. 3, separate instances of the hypernetwork 124 are illustrated to indicate different operations of the hypernetwork 124 for different input timestep values. For example, a first hypernetwork instance 124A is associated with a timestep t, and is configured to generate first weights (\hat{Θ}ₜ) 260A. As another example, a second hypernetwork instance 124B is associated with a timestep t+1 that is subsequent to the timestep t, and is configured to generate second weights (\hat{Θ}ₜ₊₁) 260B. Accordingly, although multiple instances of the hypernetwork 124 are shown in FIG. 3, such a depiction is for illustration and, in other embodiments, the hypernetwork trainer 220 may only include a single instance of the hypernetwork 124.

The hypernetwork (H_{φ}) 124 may be initialized with hypernetwork weights (φ) 254. Each instance (e.g., the instances 124A and 124B) of the hypernetwork 124 may share the same hypernetwork weights (φ) 254. Additionally, the hypernetwork 124 may receive parameters Θ₀ that are used to initialize a task specific model, such as occupancy network (O_{Θ}), as described further herein. The first hypernetwork instance 124A may generate the first weights (\hat{Θ}ₜ) 260A as: \hat{Θ}ₜ=H_{φ} (Θ₀, z, t). The second hypernetwork instance 124B may generate the second weights (\hat{Θ}ₜ₊₁) 260B as: \hat{Θ}ₜ₊₁=H_{φ}(Θ₀, z, t+1).

The occupancy generator 368 is configured to determine an occupancy o of the sample 250, such as a ground truth occupancy of the sample 250. For example, the occupancy generator 368 may be configured to determine the occupancy o based on the query points (q) 342 and the shape(s) 346. To illustrate, the occupancy generator 368 may be configured to perform a find_occupancy( ) operation, and the occupancy o=find_occupancy (q, s). In some embodiments, the occupancy o is a ground truth occupancy of the sample 250, and the ground truth occupancy of the sample 250 may indicate, for a given query point of the query points 342, whether the location of the query point is inside or outside of the shape 346.

The task specific operator 370 includes a stop gradient determiner 372, an occupancy model (O_{Θ}) 374, and a ground truth weight estimator 376. Although the task specific operator 370 is described as including each of the stop gradient determiner 372, the occupancy model (O_{Θ}) 374, and the ground truth weight estimator 376, in other embodiments, the task specific operator 370 may not include one or more of the stop gradient determiner 372, the occupancy model (O_{Θ}) 374, or the ground truth weight estimator 376. As an illustrative example, the task specific operator 370 may not include the stop gradient determiner 372 and the ground truth weight estimator 376, each of which may be included in the hypernetwork trainer 220 and may be separate from the task specific operator 370.

The stop gradient determiner 372 is configured to perform a stop gradient operation based on the first weights (\hat{Θ}ₜ) 260A. For example, the stop gradient determiner 372 may perform the stop gradient operation StopGradient (\hat{Θ}ₜ) and output estimated ground truth weights Θₜ for timestep t. In some embodiments, the stop gradient operation is performed to “lock” or fix the estimated ground truth weights Θₜ as an input to the occupancy model 374 and to thereby prohibit one or more values from being updated during a back propagation associated with determining one or gradients and/or updated hypernetwork weights.

The occupancy model (O_{Θ}) 374 is configured to receive the parameters Θₜ and perform an occupancy operation O_{Θ}_{ₜ}( ) based on the query points (q) 342. For example, the occupancy model 374 may perform the occupancy operation to determine a predicted occupancy ô. In some embodiments, the occupancy model (O_{Θ}) 374 includes or corresponds to the generative model 126 of FIG. 1.

The ground truth weight estimator 376 is configured to determine ground truth weights Θₜ₊₁ for timestep t+1. For example, the ground truth weight estimator 376 may determine the ground truth weights Θₜ₊₁ for timestep t+1 based on the estimated ground truth weights Θₜ for timestep t, the predicted occupancy ô, and the ground truth occupancy o. To illustrate, the ground truth weight estimator 376 may determine the ground truth weights Θₜ₊₁ for timestep t+1 as:

$${Θ}_{t + 1} = {Θ}_{t} - η {∇}_{{Θ}_{t}} MSE ( \hat{o} , o ) ,$$

where η is a learning rate value, ∇_{Θ}_{ₜ} is gradient associated with the parameters Θₜ, and MSE is mean squared error. In some implementations, MSE(ô, o) may be replaced with the loss function L(Θ, z).
In some embodiments, in each training iteration, the hypernetwork generates an estimate of the task-specific parameters Θₜ at timestep t based on the input z and the timestep t. Given this estimate, a gradient of the loss function can be computed with respect to the task-specific weights at the timestep, ∇_{Θ}_{ₜ}L (Θₜ, z), and pa single optimization step can be performed to update the weights to Θₜ₊₁. This process may be repeated for each timestep in the trajectory, generating a sequence of updates:

$${Θ}_{t + 1} = {Θ}_{t} - η {∇}_{{Θ}_{t}} L ( {Θ}_{t} , z ) .$$

The hypernetwork H_{φ} 324 is thus supervised to match the gradients at each step of the optimization:

$${ℒ}_{grad} = {‖ {∇}_{{θ}_{t}} L ( {θ}_{t} , x ) - {∇}_{{θ}_{t}} {h}_{ϕ} ( x , t ) ‖}^{2} .$$

Accordingly, the hypernetwork H_{φ} 324 can learn the entire trajectory, capturing a distribution of parameters over the optimization process rather than a single converged solution. By supervising the hypernetwork to match the gradient of the weights with respect to the optimization step, the need for precomputing target weights is avoided. During each training step, a single task-specific optimization step is computed for the task-specific network whose weights are estimated weights by the hypernetwork H_{φ} 324. Additionally, a difference between the estimated change in parameters over the timesteps and a ground truth direction (found through the task-specific optimization) can be minimized. This supervision strategy allows the hypernetwork H_{φ} 324 to estimate a trajectory of parameters that, at each step, reflects a compatible state across al samples in the dataset. Ultimately, at inference time, the estimated parameters which correspond with the hypernetwork's final timestep, represent a well-converged solution for each sample, learned in a manner that reduces compute costs and better captures a distribution of possible outcomes. Additionally, or alternatively, at inference, only a single forward pass is needed sign the hypernetwork H_{φ} 324 single step estimates the parameters for all timesteps.

The gradient determiner 262 is configured to receive the first weights (Θₜ) 260A, the second weights (Θₜ₊₁) 260B, the estimated ground truth weights Θₜ for timestep t, and the ground truth weights Θₜ₊₁ for timestep t+1. The gradient determiner 262 may determine the estimated gradient \hat{d} 270 based on the first weights (\hat{Θ}ₜ) 260A, the second weights (\hat{Θ}ₜ₊₁) 260B. For example, the gradient determiner 262 may determine the estimated gradient \hat{d} 270 as: \hat{d}=\hat{Θ}ₜ₊₁-Ot. The gradient determiner 262 may determine the ground truth gradient d 272 based on the estimated ground truth weights Θₜ for timestep t, and the ground truth weights Θₜ₊₁ for timestep t+1. For example, the gradient determiner 262 may determine the ground truth gradient d 272 as: d=Θₜ₊₁−Θₜ.

The hypernetwork weights updater 264 is configured to receive the estimated gradient \hat{d} 270 and the ground truth gradient d 272. The hypernetwork weights updater 264 may determine the updated hypernetwork weights (φ) 274 based on the estimated gradient \hat{d} 270 and the ground truth gradient d 272. For example, the updated hypernetwork weights (φ) 274 may be determined as:

$$( the updated weights ϕ 274 ) = ( the weights ϕ 254 ) - η {∇}_{Θ} MSE ( \hat{d} , d ) ,$$

where η is a learning rate value, ∇_{Θ}_{ₜ} is gradient associated with the parameters Θₜ, and MSE is mean squared error. The updated hypernetwork weights (φ) 274 may be provided to the hypernetwork 124 to initialize the hypernetwork (H_{φ}) 124 for a next sample selected from the data set (D) 232. If no more samples are to be selected from the data set (D) 232, the updated hypernetwork weights (φ) 274 are identified as the trained hypernetwork weights for the hypernetwork 124.

In some embodiments, the techniques described herein may enforce a parameterization which forces H_{φ}(Θ₀, t=0)=Θ₀ to ensure that there is no offset or shift of the entire trajectory when gradient is satisfied. The model may be parameterized as an offset from the input Θ₀, conditioned on t as in:

$${H}_{ϕ} ( {Θ}_{0} , t ) = {Θ}_{0} + \frac{t}{T} {h}_{ϕ} ( {Θ}_{0} , t ) .$$

With this parameterization, as long as the gradient at every timestep is satisfied, the optimization trajectory is satisfied.

In some embodiments, the processor 108 is configured to execute the instructions 109 (e.g., executable code) to implement one or more operations described with respect to the hypernetwork trainer 220. An illustrative example of pseudo-code for operation of the hypernetwork trainer 220 for one sample (e.g., the sample 250) includes:

| | |
|---|---|
| H_{φ} ← Hypernetwork( ) | > Hypernetwork with parameters φ < |
| O_{Θ}_{_{O}} ← OccupancyNetwork( ) | > Task specific network with parameters Θ_{O} < |
| E ← ShapeEncoder( ) | > Pretrained VAE encoder < |

D ← Dataset( )
while True do

| | |
|---|---|
| q, s ← next(D) | > Query points, And shape s < |
| o ← find_occupancy (q, s) | > Find occupancy of q given s < |
| z ← E(s) | > Encode the shape < |

t ← sample from [0, T]

| | |
|---|---|
| \hat{Θ}ₜ ← H_{φ}(Θ_{O}, z, t) | > Estimate weights for timestep t < |

```
  Task Specific Optimization:
    Θₜ ← StopGradient (\hat{Θ}ₜ)
```

| | |
|---|---|
| ô ← O_{Θ}_{ₜ}(q) | > Predicted Occupancies < |
| Θₜ₊₁ ← Θₜ − η∇_{Θ}_{ₜ}MSE(ô, o) | > GT weights for timestep t+1 < |
| \hat{d} ← H_{φ}(Θ_{O}, z, t+1) − H_{φ}(Θ_{O}, z, t) | > Estimate gradient < |
| d ← Θₜ₊₁ − Θₜ | > GT gradient < |
| φ ← φ − η∇_{Θ}MSE(\hat{d}, d) | > Update Hypernetwork Parameters < |

end while
In the pseudo-code, “ > < ” indicates a comment between “ > ” and “ < ”.

In some embodiments, samples may be optimized along with the hypernetwork such that all samples remain in a comparable space and a large precompute cost is reduced or eliminated. The hypernetwork may be supervised to match the gradients of the optimization trajectory such that the partially converged weights may be estimated for all timesteps t∈(0, T), where 0 represents initialization and T represents full convergence. As an example, training may involve estimating the partially converged weights for a particular timestep, applying the task-specific loss to these weights, and yielding ground truth weights for t+1 given t. A loss is then applied between the hypernetwork's estimated gradient H (c, t+1)−H(c, t) and the ground truth trajectory, where H is the hypernetwork, c is a condition, and t is the timestep. This means each condition only needs to be paired with a single gradient step, significantly reducing compute requirements.

It is noted that although the hypernetwork trainer 220 of FIG. 3 is described with reference to the occupancy model (O_{Θ}) 374, in other embodiments the hypernetwork trainer may be configured with respect to a diffusion model (that is associated with or corresponds to the generative model 126). In some such embodiments, the occupancy generator 368 may be replaced with a ground truth generator configured to output a ground truth associated with a sample (e.g., the sample 250).

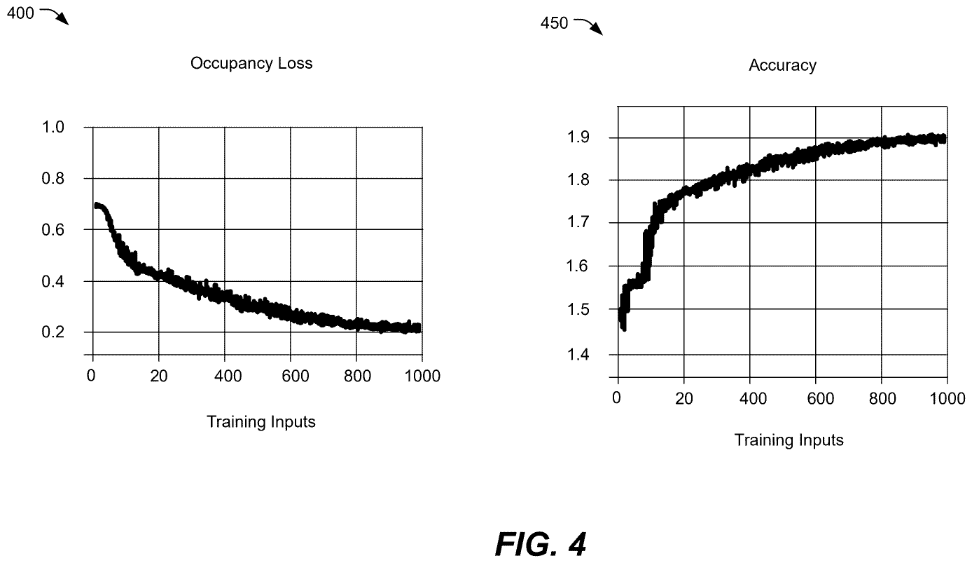

FIG. 4 depicts graphs to illustrate an example of a training technique for a hypernetwork, in accordance with one or more aspects of the present disclosure. For example, the graphs include a first graph 400 and a second graph 450 associated with a training technique for the hypernetwork 124, such as the training technique performed by the hypernetwork trainer 220 of FIG. 2 or 3.

The first graph 400 is a graph of occupancy loss. The first graph 400 illustrates a number of training inputs (e.g., a number of timesteps t) along the x-axis, and indicates a percentage of occupancy loss along the y-axis. In some embodiments, the occupancy loss may be between the ground truth occupancy o and the predicted ô, where the predicted ô is determined as O_{Θ}_{ₜ}(q) for timestep t in [0, T]. Additionally, or alternatively, the occupancy loss may be measured using binary cross entropy. As indicated by the first graph 400, an occupancy loss associated with training the hypernetwork 124 generally decreases as the number of training inputs increases.

The second graph 450 is a graph of accuracy. The second graph 450 illustrates a number of training inputs (e.g., a number of timesteps t) along the x-axis, and an accuracy metric along the y-axis. As indicated by the second graph 450, an accuracy associated with training the hypernetwork 124 generally increases as the number of training inputs increases. In some embodiments, the accuracy may be determined using an Intersection over Union (IoU) Score in which the intersection area is the overlapping region between a generated 3D shape and the ground truth shape, and the union area is the total area covered by both the generated shape and the ground truth shape, including any overlapping regions. The IoU can be calculated as the ratio of the intersection area to the union area. The graphs 400 and 450 thus illustrate that sampling higher values of t shows a smooth progression toward convergence.

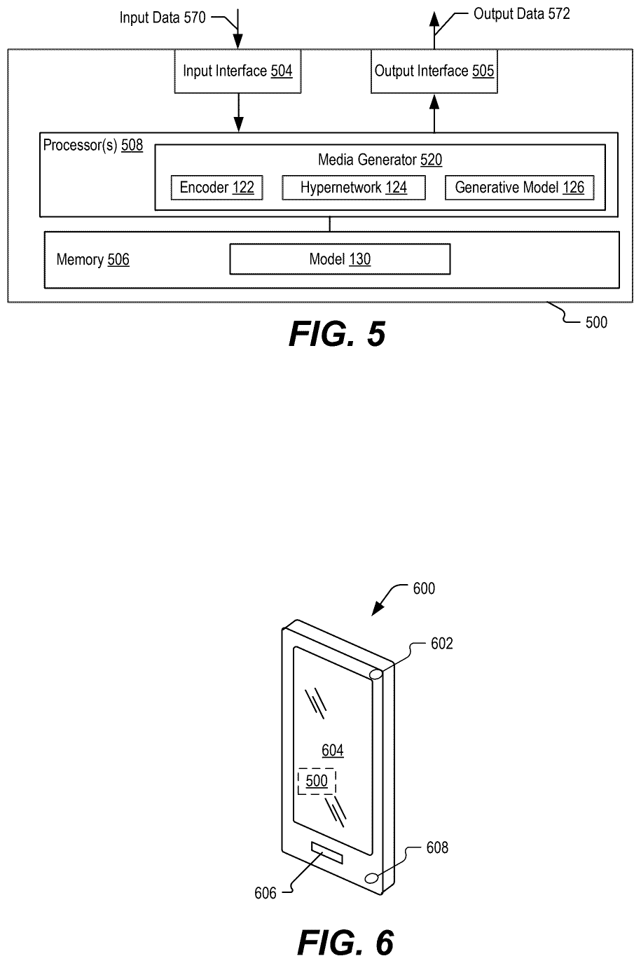

FIG. 5 depicts a diagram of an example of an integrated circuit 500 operable to generate media data based on a hypernetwork and a generative model, in accordance with some examples of the present disclosure. The integrated circuit 500 includes one or more processors 508 (herein after referred to as the “processor 508”) and a memory 506. The processor 508 and the memory 506 may include or correspond to the processor 108 and the memory 106, respectively. The processor 508 may include the media generator 520. The media generator 520 may include or correspond to the media generator 120, hypernetwork trainer 220, or a combination thereof. The media generator 520 includes the encoder 122, the hypernetwork 124, and the generative model 126. The memory 506 includes (e.g., stores) the model 130. Although the media generator 520 includes each of the encoder 122, the hypernetwork 124, and the generative model 126 in the embodiment shown, in other embodiments, the encoder 122, the hypernetwork 124, and/or the generative model 126 may be included in the model 130 and be accessible (e.g., retrievable) by the media generator 520. Additionally, or alternatively, although the integrated circuit 500 includes each of the encoder 122, the hypernetwork 124, and the generative model 126 in the embodiment shown, in other embodiments, the encoder 122, the hypernetwork 124, and/or the generative model 126 may not be included in the integrated circuit 500.

The integrated circuit 500 also includes an input interface 504, such as one or more bus interfaces, to enable the integrated circuit 500 to receive signals representing input data 570 for processing. For example, the input data 570 can correspond to or include the instructions 109, the input data 115, the media data 131, the media input 150, the data set 232, or a combination thereof.

The integrated circuit 500 also includes an output interface 505, such as a bus interface, to enable the integrated circuit 500 to output signals representing output data 572. For example, the output data 572 can correspond to or include the encoder 122, the hypernetwork 124, the generative model 126, the model 130, the media data 131, the media input 150, the media output 160, the data set 232, or a combination thereof.

The integrated circuit 500 including the media generator 520 and the model 130 enables implementation of training or use of the hypernetwork 124 and/or the generative model 126 in a system or a device. For example, the system or the device may include a mobile device (e.g., a mobile phone or tablet) as depicted in FIG. 6, a wearable electronic device as depicted in FIG. 7, a voice-controlled speaker system as depicted in FIG. 8, a camera as depicted in FIG. 9, a virtual reality, mixed reality, or augmented reality headset as depicted in FIG. 10, a mixed reality or augmented reality glasses device, as described with reference to FIG. 11, or a vehicle as depicted FIG. 12.

In some embodiments, the system or the device that includes the integrated circuit 500 also includes or is coupled to an image sensor (e.g., a camera), an input device (e.g., a microphone, a keyboard or touch screen, etc.), a display device, a speaker, a modem, or a combination thereof. For example, the image sensor, the input device, the display device, the speaker, and the modem may include or correspond to the image sensor 112, the input device 114, the display device 116, the speaker 117, and the modem 118, respectively.

In some embodiments, the system or the device that includes the integrated circuit 500 is operable to train a hypernetwork for a generative model. For example, the media generator 520 may train a hypernetwork to generate the hypernetwork 124 for the generative model 126. To generate the trained hypernetwork 124, a set of weight values (e.g., a set of parameters) of the hypernetwork 124 may be determined based on a data set of multiple examples, such as a data set of multiple images. For example, the data set of multiple examples may be provided to by a user to customize (or personalize) an output of the generative model 126. To illustrate, the media generator 520 (e.g., the hypernetwork trainer 220) may use a gradient trajectory technique to generate the trained hypernetwork 124 (having a set of weight values determined based on the training). The set of weight values (e.g., the set of parameters) of the trained hypernetwork 124 may be a common set of weight values for the multiple training examples (e.g., media content) of the data set 232.

Additionally, or alternatively, in some embodiments, the system or the device that includes the integrated circuit 500 is operable to generate media data based on the hypernetwork 124 and the generative model 126. For example, the processor 508 may receive, via the input interface 504, a request to generate media content via the hypernetwork 124 and/or the generative model 126. Based on the request, the encoder 122 may generate an encoded latent input. Additionally, the hypernetwork 124 may be queried, based on the encoded latent input, to generate weights to be used to initialize the generative model 126. After the generative model 126 is initialized based on the generated weights, the generative model 126 generates a media output associated with the request.

FIG. 6 depicts a diagram of a mobile device 600 operable to generate media data based on a hypernetwork and a generative model, in accordance with some examples of the present disclosure. The mobile device 600 may include or correspond to a phone or a tablet, as illustrative, non-limiting examples. The mobile device 600 includes a camera 602 (e.g., an image sensor), a display 604 (e.g., a display screen), a microphone 606, a speaker 608, and the integrated circuit 500. Components of the integrated circuit 500, including the media generator 520 and the model 130, are integrated in the mobile device 600 and are illustrated using dashed lines to indicate internal components that are not generally visible to a user of the mobile device 600.

FIG. 7 depicts a diagram of a wearable electronic device 700 operable to generate media data based on a hypernetwork and a generative model, in accordance with some examples of the present disclosure. The wearable electronic device 700 may include or correspond to a “smart watch,” as an illustrative, non-limiting example. The wearable electronic device 700 includes a camera 702 (e.g., an image sensor), a display 704 (e.g., a display screen), a microphone 706, a speaker 708, and the integrated circuit 500. Components of the integrated circuit 500, including media generator 520 and the model 130, are integrated in the wearable electronic device 700 and are illustrated using dashed lines to indicate internal components that are not generally visible to a user of the wearable electronic device 700.

FIG. 8 is a diagram of a voice-controlled speaker system 800 operable to generate media data based on a hypernetwork and a generative model, in accordance with some examples of the present disclosure. The voice-controlled speaker system 800 may include or correspond to a wireless speaker and voice activated device, as an illustrative, non-limiting example. The voice-controlled speaker system 800 can have wireless network connectivity and is configured to execute an assistant operation. The voice-controlled speaker system 800 includes a camera 802 (e.g., an image sensor), a display 804 (e.g., a display screen), a microphone 806, a speaker 808, and the integrated circuit 500. Components of the integrated circuit 500, including the media generator 520 and the model 130, are integrated in the voice-controlled speaker system 800 and are illustrated using dashed lines to indicate internal components that are not generally visible to a user of the voice-controlled speaker system 800.

FIG. 9 is a diagram of a camera device 900 operable to generate media data based on a hypernetwork and a generative model, in accordance with some examples of the present disclosure. The camera device 900 includes an image sensor 902, a display 904 (e.g., a display screen), a microphone 906, a speaker 908, and the integrated circuit 500. Components of the integrated circuit 500, including the media generator 520 and the model 130 are integrated in the camera device 900 and are illustrated using dashed lines to indicate internal components that are not generally visible to a user of the camera device 900.

FIG. 10 is a diagram of a headset 1000, such as a virtual reality, mixed reality, or augmented reality headset, operable to generate media data based on a hypernetwork and a generative model, in accordance with some examples of the present disclosure. A visual interface device is positioned in front of the user's eyes to enable display of augmented reality, mixed reality, or virtual reality images or scenes to the user while the headset 1000 is worn. The headset 1000 also includes a camera 1002 (e.g., an image sensor), a display 1004 (e.g., a display screen), a microphone 1006, a speaker 1008, and the integrated circuit 500. Components of the integrated circuit 500, including the media generator 520 and the model 130, are integrated in the headset 1000 and are illustrated using dashed lines to indicate internal components that are not generally visible to a user of the headset 1000.

FIG. 11 is a diagram of a mixed reality or augmented reality glasses device 1100 operable to generate media data based on a hypernetwork and a generative model, in accordance with some examples of the present disclosure. The glasses 1100 include a holographic projection unit 1104 configured to project visual data onto a surface of a lens 1105 or to reflect the visual data off of a surface of the lens 1105 and onto the wearer's retina. The glasses 1100 also include a camera 1102 (e.g., an image sensor), a microphone 1106, a speaker 1108, and the integrated circuit 500. Components of the integrated circuit 500, including the media generator 520 and the model 130, are integrated in the glasses 1100 and are illustrated using dashed lines to indicate internal components that are not generally visible to a user of the glasses 1100.

FIG. 12 is a diagram of a second example of a vehicle 1200 operable to generate media data based on a hypernetwork and a generative model, in accordance with some examples of the present disclosure. The vehicle 1200 may include or correspond to a car (e.g., a land craft), a watercraft, or an aircraft, such as a passenger aircraft or a delivery drone. The vehicle 1200 includes a camera 1202 (e.g., an image sensor), a display 1204 (e.g., a display screen), a microphone 1206, one or more speakers 1208, and the integrated circuit 500. Components of the integrated circuit 500, including the media generator 520 and the model 130, are integrated in the vehicle 1200 and are illustrated using dashed lines to indicate internal components that are not generally visible to a user of the vehicle 1200.

In a particular example of one or more of the devices of FIGS. 6-12, the integrated circuit 500 is operable to generate media data based on the hypernetwork 124 and the generative model 126. For example, based on a request to generate media content, the integrated circuit 500 may generate an encoded latent input and query, based on the encoded latent input, the hypernetwork 124 to generate weights to be used to initialize the generative model 126. After the generative model 126 is initialized based on the generated weights, the integrated circuit 500 may generate a media output associated with the request. In some embodiments, the generated media output may be stored at a memory of the integrated circuit 500, sent to another device via a modem coupled to the integrated circuit, output via a display or speaker of the one or more devices of FIGS. 6-12, or a combination thereof. One technical advantage of implementing the hypernetwork 124 implemented by the one or more devices of FIGS. 6-12 as described above is that the hypernetwork 124 enables a greater level of personalization of the generative model 126 when the hypernetwork 124 has been trained on a large data set that has not been limited or restricted based on precompute requirements.

The embodiments of the systems or devices as described with reference to FIGS. 6-12 are described, respectively, as including a display, a microphone, a speaker, a camera, or a combination thereof. As described with reference to FIGS. 6-12, the display, the microphone, the speaker, the camera may include or correspond to the display device 116, the input device 114, the speaker 117, and the image sensor 112, respectively. It is noted that in other embodiments of the systems or devices of FIGS. 6-12, one or more of the systems or devices of FIGS. 6-12 may not include the display, the microphone, the speaker, the camera, or a combination thereof. Additionally, or alternatively, one or more of the systems or devices of FIGS. 6-12 may include an additional component. For example, the additional component may include a modem, such as the modem 118.

FIG. 13 is a diagram of an example of a method 1300 of generating media data based on a hypernetwork and a media generation model, in accordance with some aspects of the present disclosure. In a particular aspect, one or more operations of the method 1300 are performed by the system 100, the device 102, the processor 108, the media generator 120, the hypernetwork trainer 220, the integrated circuit 500, the processor 508, the media generator 520, one or more of the devices of FIGS. 6-12, or a combination thereof.

In some embodiments, the method 1300 includes, at block 1302, obtaining a media input. For example, the media input may include or correspond to the media data 131, the media input 150, or a combination thereof. The media input may include image data, video data, audio data, or a combination thereof.

At block 1304, the method 1300 includes generating an encoded latent input based on the media input. For example, the encoded latent input may include or correspond to the latent input 152. In some embodiments, generating the encoded latent input includes generating the encoded latent input at an autoencoder. For example, the autoencoder may include or correspond to the encoder 122.

At block 1306, the method 1300 further includes querying, based on the encoded latent input, a hypernetwork model to generate weights. For example, the hypernetwork model may include or correspond to the hypernetwork 124, the model 130, or a combination thereof. The weights may include or correspond to the weights 154.

At block 1308, the method 1300 includes generating, via a generative model initialized based on the generated weights, a media output based on the media input. For example, the generative model and the media output may include or correspond to the generative model 126 and the media output 160, respectively. In some aspects, the generative model includes a diffusion model or an occupancy model. Additionally, or alternatively, in some embodiments, the method 1300 includes initializing the generative model based on the generated weights. For example, the generative model 126 may be initialized based on the weights 154 prior to the generative model 126 generating the media output 160.

In some embodiments, the method 1300 includes receiving a request to generate the media output. For example, the request may include or correspond to the input data 115. The request includes a prompt, and the media output can be generated based on the prompt. The prompt may include a unique identifier, such as a trigger term, that indicates or identifies the hypernetwork. Additionally, or alternatively, the prompt may include or indicate a context input, such as a word, phrase, sound, or image, associated with a requested context of the media output.

In some embodiments, the method 1300 includes displaying the media output. For example, the media output may be displayed via a display device, such as the display device 116 or a display device of one of the devices of FIGS. 6-12. The method 1300 may also include receiving a request to modify the media output. For example, the request to modify the media output may include or correspond to the input data 115. Based on the request, at least one weight of the generated weights used to initialize the generative model can be modified. In some such examples, the method 1300 further includes generating, via the generative model having the modified at least one weight, another media output based on the media input. The other media output that is generated via the generative model having the modified at least one weight may be different from the media output.

In some embodiments, the method 1300 may include obtaining a data set of multiple training examples. For example, the data set of multiple training examples may include or correspond to the media data 131, the media input 150, the data set 232, the sample 250, or a combination thereof. In a particular example, the data set of multiple training examples includes the media input. Additionally, or alternatively, the method 1300 includes receiving a request to personalize the generative model based on the data set of multiple training examples. The request may include or correspond to the input data 115. In some examples, the method 1300 includes obtaining, based on the request, the hypernetwork trained on the data set of multiple training examples.

In some embodiments, the method 1300 includes training the hypernetwork based on the data set of multiple training examples. To perform the training of the hypernetwork, the training of the hypernetwork may be performed at the same device that generates the media output or at another device. If the training is performed at the other device, the method 1300 may include transmitting, to the other device, the data set of multiple training examples, one or more models, one or more parameters or weights, an indicator of the one or more models, or a combination thereof.

Alternatively, if the training is performed at the same device, to perform the training, the method 1300 includes initializing parameters of the hypernetwork, and obtaining initial parameters of the generative model. The parameters of the hypernetwork and the initial parameters of the generative model may include or correspond to the hypernetwork weights 254 and the generative model parameters 256, respectively. The method 1300 also may include generating, by the hypernetwork based on a random sample of the data set of multiple training examples first estimated weights of the generative model and second estimated weights of the generative model. For example, the first estimated weights and the second estimated weights may include or correspond to the first weights 260A and the second weights 260B, respectively. The first estimated weights may be associated with a first timestep, and the second estimated weights may be associated with a second timestep that is subsequent to the first timestep. The method 1300 may include determining, based on the first estimated weights and the second estimated weights, an estimated gradient. Additionally, or alternatively, the method 1300 can include determining, based on the initial parameters of the generative model and the first estimated weights, a ground truth gradient. The estimated gradient and the ground truth gradient may include or correspond to the estimated gradient 270 and the ground truth gradient 272, respectively. The method 1300 may include updating, based on the estimated gradient and the ground truth gradient, the parameters of the hypernetwork to generate first updated parameters. For example, the first updated parameters may include or correspond to the updated hypernetwork weights 274. In some embodiments, the method 1300 includes generating, by the hypernetwork and based on the first updated parameters, second updated parameters for the hypernetwork based on a second training example of the data set of multiple training examples.

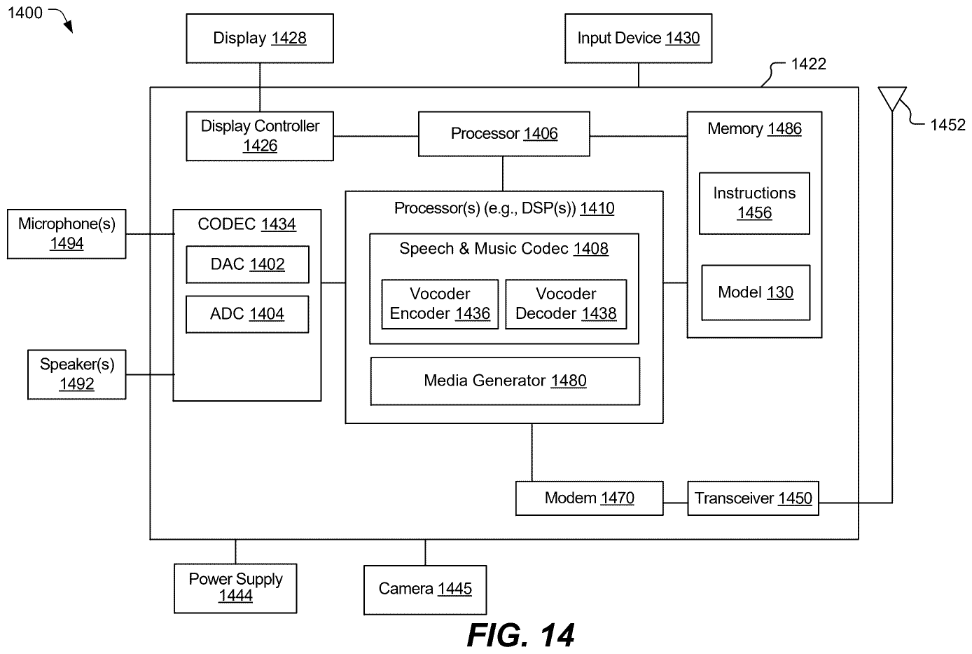

The method 1300 of FIG. 13 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1300 of FIG. 13 may be performed by a processor that executes instructions, such as described with reference to FIG. 14.

It is noted that one or more blocks (or operations) described with reference to FIG. 13 may be combined with one or more blocks (or operations) described with reference to another of the figures. For example, one or more blocks (or operations) of FIG. 13 may be combined with one or more blocks (or operations) of FIG. 1. As another example, one or more blocks associated with FIG. 13 may be combined with one or more blocks (or operations) associated with FIGS. 2-3. Additionally, or alternatively, one or more operations described above with reference to FIGS. 1-13 may be combined with one or more operations described with reference to FIG. 14.

Referring to FIG. 14, FIG. 14 is a block diagram of an illustrative example of a device 1400 that is operable to generate media data based on a hypernetwork and a generative model, in accordance with one or more aspects of the present disclosure. In various implementations, the device 1400 may have more or fewer components than illustrated in FIG. 14. In an illustrative implementation, the device 1400 may correspond to the device 102. In an illustrative implementation, the device 1400 may perform one or more operations described with reference to FIGS. 1-13.

In a particular implementation, the device 1400 includes a processor 1406 (e.g., a central processing unit (CPU)). The device 1400 may include one or more additional processors 1410 (e.g., one or more DSPs). In a particular aspect, the processor 108 of FIG. 1 or the processor 508 of FIG. 5 corresponds to the processor 1406, the processors 1410, or a combination thereof. The processors 1410 may include a speech and music coder-decoder (CODEC) 1408 that includes a voice coder (“vocoder”) encoder 1436, a vocoder decoder 1438, or a combination thereof. Additionally, or alternatively, the processors 1410 may include a media generator 1480. The media generator 1480 may include or correspond to the media generator 120, the media generator 520, or a combination thereof. In some embodiments, the processor 1406, the processors 1410, or a combination thereof, may include or be configured to perform one or more operations as described with reference to the hypernetwork trainer 220.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a graphics processing unit (GPU) are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1400 may include a memory 1486 and a CODEC 1434. The memory 1486 may include or correspond to the memory 106 or 506. The memory 1486 may include instructions 1456, that are executable by the one or more additional processors 1410 (or the processor 1406) to implement the functionality described with reference to the media generator 120, 520, or 1480, the hypernetwork trainer 220, or both. The instructions 1456 may include or correspond to the instructions 109. The memory 1486 also includes the model 130. The model 130 may include or correspond to the encoder 122, the hypernetwork 124, the generative model 126, or a combination thereof. The device 1400 may include a modem 1470 coupled, via a transceiver 1450, to an antenna 1452. The modem 1470 may include or correspond to the modem 118.

The device 1400 may include a display 1428 coupled to a display controller 1426. The display 1428 may include or correspond to the display device 116. One or more speakers 1492 and microphone(s) 1494 may be coupled to the CODEC 1434. The one or more speakers 1492 and the microphone 1494 may include or correspond to the speaker 117 and the input device 114, respectively. The CODEC 1434 may include a digital-to-analog converter (DAC) 1402, an analog-to-digital converter (ADC) 1404, or both. In a particular implementation, the CODEC 1434 may receive analog signals from the microphone(s) 1494, convert the analog signals to digital signals using the analog-to-digital converter 1404, and provide the digital signals to the speech and music codec 1408. In a particular implementation, the speech and music codec 1408 may provide digital signals to the CODEC 1434. The CODEC 1434 may convert the digital signals to analog signals using the digital-to-analog converter 1402 and may provide the analog signals to the speaker 1492.

In a particular implementation, the device 1400 may be included in a system-in-package or system-on-chip device 1422. In a particular implementation, the memory 1486, the processor 1406, the processors 1410, the display controller 1426, the CODEC 1434, and the modem 1470 are included in the system-in-package or system-on-chip device 1422. In a particular implementation, an input device 1430, a power supply 1444, and a camera 1445 are coupled to the system-in-package or the system-on-chip device 1422. For example, the input device 1430 and the camera 1445 may include or correspond to the input device 114 and the image sensor 112, respectively. In some examples, the input device 1430 may include or be associated with the display device 116 or the display 1428, such as a touchscreen display. Moreover, in a particular implementation, as illustrated in FIG. 14, the display 1428, the input device 1430, the speaker(s) 1492, the microphone(s) 1494, the antenna 1452, the power supply 1444, and the camera 1445 are external to the system-in-package or the system-on-chip device 1422. In a particular implementation, each of the display 1428, the input device 1430, the speaker(s) 1492, the microphone(s) 1494, the antenna 1452, the power supply 1444, and the camera 1445 may be coupled to a component of the system-in-package or the system-on-chip device 1422, such as an interface or a controller.

The device 1400 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining a media input. For example, the means for obtaining the media input can include the device 102, the memory 106, the processor 108, the image sensor 112, the media generator 120, the encoder 122, the integrated circuit 500, the processor 508, the memory 506, the media generator 520, the mobile device 600, the wearable electronic device 700, the voice-controlled speaker system 800, the camera device 900, the headset 1000, the glasses 1100, the vehicle 1200, the device 1400, the processor 1406, the processor(s) 1410, the system-in-package or the system-on-chip device 1422, the camera 1445, the media generator 1480, the memory 1486, other circuitry configured to obtain a media input, or a combination thereof.

The apparatus also includes means for generating an encoded latent input based on the media input. For example, the means for generating the encoded latent input can include the device 102, the processor 108, the media generator 120, the encoder 122, the integrated circuit 500, the processor 508, the media generator 520, the mobile device 600, the wearable electronic device 700, the voice-controlled speaker system 800, the camera device 900, the headset 1000, the glasses 1100, the vehicle 1200, the device 1400, the processor 1406, the processor(s) 1410, the system-in-package or the system-on-chip device 1422, the media generator 1480, other circuitry configured to generate an encoded latent input, or a combination thereof.

The apparatus further includes means for querying, based on the encoded latent input, a hypernetwork model to generate weights. For example, the means for querying the hypernetwork model can include the device 102, the processor 108, the media generator 120, the generative model 126, the integrated circuit 500, the processor 508, the media generator 520, the mobile device 600, the wearable electronic device 700, the voice-controlled speaker system 800, the camera device 900, the headset 1000, the glasses 1100, the vehicle 1200, the device 1400, the processor 1406, the processor(s) 1410, the system-in-package or the system-on-chip device 1422, the media generator 1480, other circuitry configured to query a hypernetwork model, or a combination thereof.

The apparatus includes means for generating, via a generative model initialized based on the generated weights, a media output based on the media input. For example, the means for generating the media output can include the device 102, the processor 108, the media generator 120, the generative model 126, the integrated circuit 500, the processor 508, the media generator 520, the mobile device 600, the wearable electronic device 700, the voice-controlled speaker system 800, the camera device 900, the headset 1000, the glasses 1100, the vehicle 1200, the device 1400, the processor 1406, the processor(s) 1410, the system-in-package or the system-on-chip device 1422, the media generator 1480, other circuitry configured to generate a media output, or a combination thereof.

In some implementations, a non-transitory computer-readable medium (e.g., a computer-readable storage device, such as the memory 1486) includes instructions (e.g., the instructions 1456) that, when executed by one or more processors (e.g., the one or more processors 1410 or the processor 1406), cause the one or more processors to obtain a media input, and generate an encoded latent input based on the media input. The instructions, when executed by the one or more processors, also cause the one or more processors to query, based on the encoded latent input, a hypernetwork model to generate weights. The instructions, when executed by the one or more processors, further cause the one or more processors to generate, via a generative model initialized based on the generated weights, a media output based on the media input.

Particular aspects of the disclosure are described below in sets of interrelated Examples:

According to Example 1, a device includes a memory configured to store a hypernetwork and a generative model; and one or more processors, coupled to the memory, where the one or more processors are configured to obtain a media input; generate an encoded latent input based on the media input; query, based on the encoded latent input, the hypernetwork to generate weights; and generate, via the generative model initialized based on the generated weights, a media output based on the media input.

Example 2 includes the device of Example 1, where the media input includes image data, video data, or audio data.

Example 3 includes the device of Example 1 or Example 2, where the one or more processors include an autoencoder configured to generate the encoded latent input based on the media input.

Example 4 includes the device of any of Examples 1 to 3, where the generative model includes a diffusion model or an occupancy model.

Example 5 includes the device of any of Examples 1 to 4, where the one or more processors are configured to initialize the generative model based on the generated weights; and receive a request to generate the media output.

Example 6 includes the device of Example 5, where the request includes a prompt, and the media output is generated based on the prompt.

Example 7 includes the device of any of Examples 1 to 6, where the one or more processors are configured to display the media output; receive a request to modify the media output; modify, based on the request, at least one weight of the generated weights initialized at the generative model; and generate, via the generative model having the modified at least one weight, another media output based on the media input.

Example 8 includes the device of any of Examples 1 to 7, where the one or more processors are configured to obtain a data set of multiple training examples; receive a request to personalize the generative model based on the data set of multiple training examples; and obtain, based on the request, the hypernetwork trained on the data set of multiple training examples.

Example 9 includes the device of Example 8, where the data set of multiple training examples includes the media input.

Example 10 includes the device of Example 8 or Example 9, where the one or more processors are configured to train the hypernetwork based on the data set of multiple training examples.

Example 11 includes the device of any of Examples 8 to 10, where, to train the hypernetwork, the one or more processors are configured to initialize parameters of the hypernetwork; obtain initial parameters of the generative model; generate, by the hypernetwork based on a random sample of the data set of multiple training examples: first estimated weights of the generative model, the first estimated weights associated with a first timestep; and second estimated weights of the generative model, the second estimated weights associated with a second timestep that is subsequent to the first timestep; determine, based on the first estimated weights and the second estimated weights, an estimated gradient; determine, based on the initial parameters of the generative model and the first estimated weights, a ground truth gradient; update, based on the estimated gradient and the ground truth gradient, the parameters of the hypernetwork to generate first updated parameters.

Example 12 includes the device of Example 11, where, to train the hypernetwork, the one or more processors are configured to generate, by the hypernetwork and based on the first updated parameters, second updated parameters for the hypernetwork based on a second training example of the data set of multiple training examples.

Example 13 includes the device of any of Examples 1 to 12, where the one or more processors are configured to receive an input that includes a request to perform a text-based media generation, a text-based media content editing operation, a media enhancement operation, or a combination thereof; and the media input is obtained based on the input.

Example 14 includes the device of any of Examples 1 to 12, where the device also includes one or more cameras coupled to the one or more processors and configured to generate the media input; and an input device configured to receive an input that indicates a selection of the media input and provide the input to the one or more processors, where the input includes a request to generate the media output based on the generative model and the media input from the one or more cameras.

Example 15 includes the device of any of Examples 1 to 7, where the device also includes one or more cameras coupled to the one or more processors and configured to generate multiple image frames; and where the one or more processors are configured to obtain the hypernetwork trained on the multiple image frames.

Example 16 includes the device of any of Examples 1 to 15, where the device also includes a display device coupled to the one or more processors and configured to output the media output generated based on the media input.

Example 17 includes the device of any of Examples 1 to 16, where the device also includes a modem coupled to the one or more processors, the modem configured to transmit the media output generated based on the media input to a second device for output at the second device.

Example 18 includes the device of any of Examples 1 to 12, where the device also includes a microphone configured to provide an input signal to the one or more processors to cause the one or more processors to generate the media output based on the media input; and where the one or more processors are configured to perform a voice-to-text operation on the input signal to generate text data; and identify a media generation request based on the text data.

Example 19 includes the device of any of Examples 1 to 12, where the device also includes a speaker configured to output the media output.

Example 20 includes the device of any of Examples 1 to 19, where the one or more processors are integrated in a mobile phone, a tablet computer device, a wearable electronic device, a virtual reality headset, a mixed reality headset, an augmented reality headset, or a camera device.

According to Example 21, a method of operating one or more processors includes obtaining a media input; generating an encoded latent input based on the media input; querying, based on the encoded latent input, a hypernetwork model to generate weights; and generating, via a generative model initialized based on the generated weights, a media output based on the media input.

Example 22 includes the method of Example 21, where the media input includes image data, video data, or audio data.

Example 23 includes the method of Example 21 or Example 22, and the method further includes generating, at an autoencoder, the encoded latent input based on the media input.

Example 24 includes the method of any of Examples 21 to 23, where the generative model includes a diffusion model or an occupancy model.

Example 25 includes the method of any of Examples 21 to 24, and the method further includes initializing the generative model based on the generated weights; and receiving a request to generate the media output, and where the request includes a prompt, and the media output is generated based on the prompt.

Example 26 includes the method of any of Examples 21 to 25, and the method further includes displaying the media output; receiving a request to modify the media output; modifying, based on the request, at least one weight of the generated weights initialized at the generative model; and generating, via the generative model having the modified at least one weight, another media output based on the media input.

Example 27 includes the method of any of Examples 21 to 26, and the method further includes obtaining a data set of multiple training examples; receiving a request to personalize the generative model based on the data set of multiple training examples; and obtaining, based on the request, the hypernetwork trained on the data set of multiple training examples.

Example 28 includes the method of Example 27, where the data set of multiple training examples includes the media input.

Example 29 includes the method of any of Examples 27 to 28, the method further includes training the hypernetwork based on the data set of multiple training examples.

Example 30 includes the method of any of Examples 27 to 29, where training the hypernetwork includes: initializing parameters of the hypernetwork; obtaining initial parameters of the generative model; generating, by the hypernetwork based on a random sample of the data set of multiple training examples: first estimated weights of the generative model, the first estimated weights associated with a first timestep; and second estimated weights of the generative model, the second estimated weights associated with a second timestep that is subsequent to the first timestep; determining, based on the first estimated weights and the second estimated weights, an estimated gradient; determining, based on the initial parameters of the generative model and the first estimated weights, a ground truth gradient; updating, based on the estimated gradient and the ground truth gradient, the parameters of the hypernetwork to generate first updated parameters; and generating, by the hypernetwork and based on the first updated parameters, second updated parameters for the hypernetwork based on a second training example of the data set of multiple training examples.

Example 31 includes the method of any of Examples 21 to 30, and the method further includes receiving an input that includes a request to perform a text-based media generation, a text-based media content editing operation, a media enhancement operation, or a combination thereof; and where the media input is obtained based on the input.

Example 32 includes the method of any of Examples 21 to 30, and the method further includes receiving the media input from one or more cameras; and receiving, from an input device, an input that indicates a selection of the media input, where the input includes a request to generate the media output based on the generative model and the media input from the one or more cameras.

Example 33 includes the method of any of Examples 21 to 26, and the method further includes receiving, from one or more cameras coupled to the one or more processors, multiple image frames.

Example 34 includes the method of Example 33, where the one or more processors are configured to obtain the hypernetwork trained on the multiple image frames.

Example 35 includes the method of any of Examples 21 to 34, and the method further includes providing, to a display device coupled to the one or more processors, the media output generated based on the media input.

Example 36 includes the method of any of Examples 21 to 35, and the method further includes initiating transmission, via a modem coupled to the one or more processors, of the media output generated based on the media input to a second device for output at the second device

Example 37 includes the method of any of Examples 21 to 30, and the method further includes receiving, from a microphone, an input signal; and generating the media output based on the media input.

Example 38 includes the method of Example 37, and the method further includes performing a voice-to-text operation on the input signal to generate text data; and identifying a media generation request based on the text data.

Example 39 includes the method of any of Examples 21 to 30, and the method further includes providing the media output to a speaker.

Example 40 includes the method of any of Examples 21 to 39, where the one or more processors are integrated in a mobile phone, a tablet computer device, a wearable electronic device, a virtual reality headset, a mixed reality headset, an augmented reality headset, or a camera device.

According to Example 41, a non-transitory computer-readable medium storing instructions that are executable by one or more processors to cause the one or more processors to obtain a media input; generate an encoded latent input based on the media input; query, based on the encoded latent input, a hypernetwork model to generate weights; and generate, via a generative model initialized based on the generated weights, a media output based on the media input.

Example 42 includes the non-transitory computer-readable medium of Example 41, where the media input includes image data, video data, or audio data.

Example 43 includes the non-transitory computer-readable medium of Example 41 or Example 42, where the one or more processors include an autoencoder configured to generate the encoded latent input based on the media input.

Example 44 includes the non-transitory computer-readable medium of any of Examples 41 to 43, where the generative model includes a diffusion model or an occupancy model.

Example 45 includes the non-transitory computer-readable medium of any of Examples 41 to 44, where the instructions further cause the one or more processors to initialize the generative model based on the generated weights; and receive a request to generate the media output.

Example 46 includes the non-transitory computer-readable medium of Example 45, where the request includes a prompt, and the media output is generated based on the prompt.

Example 47 includes the non-transitory computer-readable medium of any of Examples 41 to 46, where the instructions further cause the one or more processors to display the media output; receive a request to modify the media output; modify, based on the request, at least one weight of the generated weights initialized at the generative model; and generate, via the generative model having the modified at least one weight, another media output based on the media input.

Example 48 includes the non-transitory computer-readable medium of any of Examples 41 to 47, where the instructions further cause the one or more processors to obtain a data set of multiple training examples; receive a request to personalize the generative model based on the data set of multiple training examples; and obtain, based on the request, the hypernetwork trained on the data set of multiple training examples.

Example 49 includes the non-transitory computer-readable medium of Example 48, where the data set of multiple training examples includes the media input.

Example 50 includes the non-transitory computer-readable medium of Example 48 or Example 49, where the instructions further cause the one or more processors to train the hypernetwork based on the data set of multiple training examples.

Example 51 includes the non-transitory computer-readable medium of any of Examples 48 to 50, where, to train the hypernetwork, where the instructions further cause the one or more processors to initialize parameters of the hypernetwork; obtain initial parameters of the generative model; generate, by the hypernetwork based on a random sample of the data set of multiple training examples: first estimated weights of the generative model, the first estimated weights associated with a first timestep; and second estimated weights of the generative model, the second estimated weights associated with a second timestep that is subsequent to the first timestep; determine, based on the first estimated weights and the second estimated weights, an estimated gradient; determine, based on the initial parameters of the generative model and the first estimated weights, a ground truth gradient; update, based on the estimated gradient and the ground truth gradient, the parameters of the hypernetwork to generate first updated parameters.

Example 52 includes the non-transitory computer-readable medium of Example 51, where, to train the hypernetwork, where the instructions further cause the one or more processors to generate, by the hypernetwork and based on the first updated parameters, second updated parameters for the hypernetwork based on a second training example of the data set of multiple training examples.

Example 53 includes the non-transitory computer-readable medium of any of Examples 41 to 52, where the instructions further cause the one or more processors to receive an input that includes a request to perform a text-based media generation, a text-based media content editing operation, a media enhancement operation, or a combination thereof; and the media input is obtained based on the input.

Example 54 includes the non-transitory computer-readable medium of any of Examples 41 to 52, where the instructions further cause the one or more processors to receive, from one or more cameras coupled to the one or more processors, the media input; and receive, from an input device, an input that indicates a selection of the media input and provide the input to the one or more processors, where the input includes a request to generate the media output based on the generative model and the media input from the one or more cameras.

Example 55 includes the non-transitory computer-readable medium of any of Examples 41 to 47, where the instructions further cause the one or more processors to receive, from one or more cameras coupled to the one or more processors, multiple image frames; and obtain the hypernetwork trained on the multiple image frames.

Example 56 includes the non-transitory computer-readable medium of any of Examples 41 to 55, where the instructions further cause the one or more processors to output, via a display device coupled to the one or more processors, the media output generated based on the media input.

Example 57 includes the non-transitory computer-readable medium of any of Examples 41 to 56, where the instructions further cause the one or more processors to transmit, via a modem coupled to the one or more processors, the media output generated based on the media input to a second device for output at the second device.

Example 58 includes the non-transitory computer-readable medium of any of Examples 41 to 52, where the instructions further cause the one or more processors to receive, from a microphone, an input signal; generate the media output based on the media input; and perform a voice-to-text operation on the input signal to generate text data; and identify a media generation request based on the text data.

Example 59 includes the non-transitory computer-readable medium of any of Examples 41 to 52, where the instructions further cause the one or more processors to output the media output via a speaker.

Example 60 includes the non-transitory computer-readable medium of any of Examples 41 to 59, where the one or more processors are integrated in a mobile phone, a tablet computer device, a wearable electronic device, a virtual reality headset, a mixed reality headset, an augmented reality headset, or a camera device.

According to Example 61, an apparatus includes means for obtaining a media input; means for generating an encoded latent input based on the media input; means for querying, based on the encoded latent input, a hypernetwork model to generate weights; and means for generating, via a generative model initialized based on the generated weights, a media output based on the media input.

Example 62 includes the apparatus of Example 61, where the media input includes image data, video data, or audio data.

Example 63 includes the apparatus of Example 61 or Example 62, and the apparatus further includes means for generating the encoded latent input based on the media input.

Example 64 includes the apparatus of any of Examples 61 to 63, where the generative model includes a diffusion model or an occupancy model.

Example 65 includes the apparatus of any of Examples 61 to 64, and the apparatus further includes means for initializing the generative model based on the generated weights; and receiving a request to generate the media output, and where the request includes a prompt, and the media output is generated based on the prompt.

Example 66 includes the apparatus of any of Examples 61 to 65, and the apparatus further includes means for displaying the media output; receiving a request to modify the media output; means for modifying, based on the request, at least one weight of the generated weights initialized at the generative model; and means for generating, via the generative model having the modified at least one weight, another media output based on the media input.

Example 67 includes the apparatus of any of Examples 61 to 66, and the apparatus further includes means for obtaining a data set of multiple training examples; means for receiving a request to personalize the generative model based on the data set of multiple training examples; and means for obtaining, based on the request, the hypernetwork trained on the data set of multiple training examples.

Example 68 includes the apparatus of Example 67, where the data set of multiple training examples includes the media input.

Example 69 includes the apparatus of any of Examples 67 to 68, and the apparatus further includes means for training the hypernetwork based on the data set of multiple training examples.

Example 70 includes the apparatus of any of Examples 67 to 69, where the means for training the hypernetwork includes: means for initializing parameters of the hypernetwork; means for obtaining initial parameters of the generative model; means for generating, in association with the hypernetwork based on a random sample of the data set of multiple training examples: first estimated weights of the generative model, the first estimated weights associated with a first timestep; and second estimated weights of the generative model, the second estimated weights associated with a second timestep that is subsequent to the first timestep; means for determining, based on the first estimated weights and the second estimated weights, an estimated gradient; means for determining, based on the initial parameters of the generative model and the first estimated weights, a ground truth gradient; means for updating, based on the estimated gradient and the ground truth gradient, the parameters of the hypernetwork to generate first updated parameters; and means for generating, in association with the hypernetwork and based on the first updated parameters, second updated parameters for the hypernetwork based on a second training example of the data set of multiple training examples.

Example 71 includes the apparatus of any of Examples 61 to 70, and the apparatus further includes means for receiving an input that includes a request to perform a text-based media generation, a text-based media content editing operation, a media enhancement operation, or a combination thereof; and where the media input is obtained based on the input.

Example 72 includes the apparatus of any of Examples 61 to 70, and the apparatus further includes means for receiving the media input from one or more cameras; and means for receiving, from an input device, an input that indicates a selection of the media input, where the input includes a request to generate the media output based on the generative model and the media input from the one or more cameras.

Example 73 includes the apparatus of any of Examples 61 to 66, and the apparatus further includes means for capturing multiple image frames.

Example 74 includes the apparatus of Example 73, and the apparatus includes means for obtaining the hypernetwork trained on the multiple image frames.

Example 75 includes the apparatus of any of Examples 61 to 74, and the apparatus further includes means for displaying the media output generated based on the media input.

Example 76 includes the apparatus of any of Examples 61 to 75, and the apparatus further includes means for transmitting the media output generated based on the media input to a second device for output at the second device.

Example 77 includes the apparatus of any of Examples 61 to 70, and the apparatus further includes means for receiving an audio input signal; and means for generating the media output based on the audio input signal.

Example 78 includes the apparatus of Example 77, and the apparatus further includes means for performing a voice-to-text operation on the input signal to generate text data; and identifying a media generation request based on the text data.

Example 79 includes the apparatus of any of Examples 61 to 70, and the apparatus further includes means for providing the media output to a speaker.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store a hypernetwork and a generative model; and
one or more processors, coupled to the memory, wherein the one or more processors are configured to:
obtain a media input;
generate an encoded latent input based on the media input;
query, based on the encoded latent input, the hypernetwork to generate weights; and
generate, via the generative model initialized based on the generated weights, a media output based on the media input.

2. The device of claim 1, wherein the media input includes image data, video data, or audio data.

3. The device of claim 1, wherein the one or more processors include an autoencoder configured to generate the encoded latent input based on the media input.

4. The device of claim 1, wherein the generative model includes a diffusion model or an occupancy model.

5. The device of claim 1, wherein the one or more processors are configured to:
initialize the generative model based on the generated weights; and
receive a request to generate the media output, and
wherein:
the request includes a prompt; and
the media output is generated based on the prompt.

6. The device of claim 1, wherein the one or more processors are configured to:
display the media output;
receive a request to modify the media output;
modify, based on the request, at least one weight of the generated weights initialized at the generative model; and
generate, via the generative model having the modified at least one weight, another media output based on the media input.

7. The device of claim 1, wherein the one or more processors are configured to:
obtain a data set of multiple training examples;
receive a request to personalize the generative model based on the data set of multiple training examples; and
obtain, based on the request, the hypernetwork trained on the data set of multiple training examples.

8. The device of claim 7, wherein the data set of multiple training examples includes the media input.

9. The device of claim 7, wherein the one or more processors are configured to train the hypernetwork based on the data set of multiple training examples.

10. The device of claim 9, wherein, to train the hypernetwork, the one or more processors are configured to:
initialize parameters of the hypernetwork;
obtain initial parameters of the generative model;
generate, by the hypernetwork based on a random sample of the data set of multiple training examples:
first estimated weights of the generative model, the first estimated weights associated with a first timestep; and
second estimated weights of the generative model, the second estimated weights associated with a second timestep that is subsequent to the first timestep;
determine, based on the first estimated weights and the second estimated weights, an estimated gradient;
determine, based on the initial parameters of the generative model and the first estimated weights, a ground truth gradient;
update, based on the estimated gradient and the ground truth gradient, the parameters of the hypernetwork to generate first updated parameters; and
generate, by the hypernetwork and based on the first updated parameters, second updated parameters for the hypernetwork based on a second training example of the data set of multiple training examples.

11. The device of claim 1, wherein:
the one or more processors are configured to receive an input that includes a request to perform a text-based media generation, a text-based media content editing operation, a media enhancement operation, or a combination thereof; and
the media input is obtained based on the input.

12. The device of claim 1, further comprising:
one or more cameras coupled to the one or more processors and configured to generate the media input; and
an input device configured to receive an input that indicates a selection of the media input and provide the input to the one or more processors, wherein the input includes a request to generate the media output based on the generative model and the media input from the one or more cameras.

13. The device of claim 1, further comprising:
one or more cameras coupled to the one or more processors and configured to generate multiple image frames; and
wherein the one or more processors are configured to obtain the hypernetwork trained on the multiple image frames.

14. The device of claim 1, further comprising:
a display device coupled to the one or more processors and configured to output the media output generated based on the media input.

15. The device of claim 1, further comprising a modem coupled to the one or more processors, the modem configured to transmit the media output generated based on the media input to a second device for output at the second device.

16. The device of claim 1, further comprising:
a microphone configured to provide an input signal to the one or more processors to cause the one or more processors to generate the media output based on the media input; and
wherein the one or more processors are configured to:
perform a voice-to-text operation on the input signal to generate text data; and
identify a media generation request based on the text data.

17. The device of claim 1, further comprising a speaker configured to output the media output.

18. The device of claim 1, wherein the one or more processors are integrated in a mobile phone, a tablet computer device, a wearable electronic device, a virtual reality headset, a mixed reality headset, an augmented reality headset, or a camera device.

19. A method of operating a processor, the method comprising:
obtaining a media input;
generating an encoded latent input based on the media input;
querying, based on the encoded latent input, a hypernetwork model to generate weights; and
generating, via a generative model initialized based on the generated weights, a media output based on the media input.

20. A non-transitory computer-readable medium storing instructions that are executable by one or more processors to cause the one or more processors to:
obtain a media input;
generate an encoded latent input based on the media input;
query, based on the encoded latent input, a hypernetwork model to generate weights; and
generate, via a generative model initialized based on the generated weights, a media output based on the media input.
